(19) United States
(12) Patent Application Publication
(10) Pub. No.: US 2026/0141583 A1
(43) Pub. Date: May 21, 2026

(54) Methods and systems for image editing

(71) Applicant: Canva Pty Ltd, Surry Hills (AU)

(72) Inventor: Stefan Sietzen, Salzburg (AT)

(73) Assignee: Canva Pty Ltd, Surry Hills (AU)

(21) Appl. No.: 19/389,275

(22) Filed: Nov. 14, 2025

(30) Foreign Application Priority Data
Nov. 18, 2024 (AU) 2024264736

(51) Int. Cl. G06T 11/00; G06T 7/90

(52) U.S. Cl. CPC G06T 11/10; G06T 7/90; G06T 2207/10024; G06T 2207/20072; G06T 2207/20081; G06T 2207/20084

(57) ABSTRACT

Embodiments relate to methods, systems and computer-readable media for editing images. An embodiment of a method for editing an image includes accessing a source image for editing, accessing a reference image, generating a mapping, wherein the mapping relates at least one source attribute value to at least one target attribute value, and modifying the source image to generate an edited image by applying the generated mapping, the edited image having at least one attribute value based on the attribute values of the reference image. Embodiments also relate to methods, systems and computer-readable media for training machine learning models. An embodiment of a method for training a machine learning model to edit an image, includes accessing a source image for editing, accessing a reference image, generating a source histogram for the source image and a reference histogram for the reference image, inputting the source histogram and the reference histogram into an encoder to generate a source histogram vector and a target histogram vector, concatenating the source histogram vector and the reference histogram vector into a concatenated vector, inputting the concatenated vector into the machine learning model, generate a mapping using the machine learning model, applying the mapping to the source image, calculating at least one loss function, and updating the parameters of the machine learning model on the basis of the at least one loss function.

### CROSS-REFERENCE TO RELATED APPLICATIONS

This application is a U.S. Non-provisional application that claims priority to and the benefit of Australian Patent Application No. 2024264736, filed 18 Nov. 2025, that is hereby incorporated by reference in its entirety.

### TECHNICAL FIELD

Described embodiments relate to systems, methods and computer program products for performing image editing. In particular, described embodiments relate to systems, methods and computer program products for editing attributes of a digital image.

### BACKGROUND

Techniques for editing attributes of an image, such as colour, brightness, contrast, and the like, often rely on manual adjustments in image editing software. Often a selected adjustment, such as increasing the brightness attribute, must be applied globally to the entire image, regardless of the values of other attributes in the image. In some techniques, adjustment of a particular colour attribute in an image must be applied globally. Alternative, techniques for selecting only pixels having a particular RGB colour value enables only those colour values to be adjusted. However, this requires selecting each colour value within an image separately and manually adjusting each until the user is satisfied with the result. These techniques are tedious and time consuming to apply, and often result in an undesirable output. For example, the edited image may have an undesirable look if it is colour washed, inconsistent, or pixelated.

Additionally, techniques which use colour warping tools often rely on fine grids with multiple rings at different distances to the centre, where manually adjusting the fine grids results in changes to colours of an image. However, these fine grids require large amounts of data to specify changes in colour attributes, and are not efficient for rendering across a network, for example, on the client-side. Moreover, they are not able to be easily or effectively constrained such that changes apply to only some attributes within an image.

It is desired to address or ameliorate one or more shortcomings or disadvantages associated with prior systems and methods for performing image editing, or to at least provide a useful alternative thereto.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

### SUMMARY

Some embodiments relate to a method for editing an image, the method comprising:
accessing a source image for editing;
accessing a reference image;
generating a mapping, wherein the mapping relates at least one source attribute value to at least one target attribute value; and
modifying the source image to generate an edited image by applying the generated mapping, the edited image having at least one attribute value based on the attribute values of the reference image.

In some embodiments, the source attribute value and the target attribute value may be colour values. The mapping may relate a plurality of source attribute values to a plurality of target attribute values, wherein each source attribute value relates to a single target attribute value. The target attribute values may be determined using at least the attribute values of the reference image.

In some embodiments, the source attribute value and the target attribute value may be colour values, wherein generating a mapping may comprise generating a mapping at least partially based on the source image and the reference image, wherein the mapping relates at least one source colour value to at least one target colour value; and wherein the edited image may have at least one colour value at least partially based on the colour values of the reference image.

In some embodiments, the edited image having at least one attribute value based on the attribute values of the reference image may comprise having the at least one attribute value closer to the one or more attribute values of the reference image. The at least one attribute value being closer to one or more attribute values of the reference image may comprise the at least one attribute value being within a specified range of the one or more attribute values of the reference image.

The at least one attribute value being closer to one or more attribute values of the reference image may comprise a first difference between the at least one attribute value and the one or more attribute values of the reference image being less than a second difference between the at least one attribute value and one or more attribute values of the source image.

In some embodiments, the method may further comprise generating a source histogram of a distribution of source attribute values for the source image. The method may further comprise generating a reference histogram of a distribution of reference attribute values for the reference image. The method may further comprise inputting the source histogram into an encoder to generate a source histogram representation. The method may further comprise inputting the reference histogram into an encoder to generate a reference histogram representation.

In some embodiments, the encoder may be a convolutional neural network (CNN).

The source histogram representation and/or the reference histogram representation may be embedding vectors. Generating the mapping may comprise combining the source image histogram representation and the target image histogram representation to produce a combined histogram representation. Generating the mapping may comprise applying a machine learning model to the combined histogram representation to generate the mapping. The mapping may comprise a three-dimensional grid.

In some embodiments, generating the mapping may comprise determining one or more control points for the mapping, the control points controlling mapping between at least one source attribute value and at least one target attribute value. The mapping may comprise a warp grid. The warp grid may be a radial warp grid. The control points may define a peripheral edge of the radial warp grid.

In some embodiments, generating the mapping may comprise: determining an offset value for each of the one or more control points, the offset value being the difference between the original position of the control point and the final position of the control point after the control point has been adjusted to reach the target attribute values; and outputting an offset array containing the offset values for each of the one or more control points.

The offset values may be X and Y offsets for each of the one or more control points. Generating the mapping may comprise constructing the mapping from the offset array.

After generating the mapping, the method may further comprise: applying the mapping to the source image and generating an adjusted histogram; comparing the adjusted histogram to the reference histogram; responsive to the distance between the adjusted histogram and the reference histogram being below a predetermined threshold, outputting the mapping.

In some embodiments, the method may further comprise, responsive to the distance between the adjusted histogram and the reference histogram being above a predetermined threshold, updating the mapping such that the distance between the adjusted histogram and the reference histogram is reduced.

In some embodiments, the method may further comprise: further adjusting one or more of the control points to update the mapping; and repeating the steps as disclosed herein until the distance between the source histogram is reduced below the predetermined threshold.

Applying the generated mapping to the source image may comprise transforming the attribute value of each pixel of the source image to the target attribute values defined in the mapping. Modifying the image may increases the similarity of attribute values between the source image and the reference image.

In some embodiments, the method may further comprise outputting the edited image. In some embodiments, the method may further comprise storing the editing image to memory. In some embodiments, the method may further comprise transmitting the edited image to a computing device.

Some embodiments relate to a method for training a machine learning model to edit an image, the method comprising:
accessing a source image for editing;
accessing a reference image;
generating a source histogram for the source image and a reference histogram for the reference image;
inputting the source histogram and the reference histogram into an encoder to generate a source histogram vector and a target histogram vector;
concatenating the source histogram vector and the reference histogram vector into a concatenated vector.
inputting the concatenated vector into the machine learning model;
generate a mapping using the machine learning model;
applying the mapping to the source image;
calculating at least one loss function; and
updating the parameters of the machine learning model on the basis of the at least one loss function.

Some embodiments relate to a non-transitory computer-readable storage medium storing instructions which, when executed by a processing device, cause the processing device to perform a method as described herein.

Some embodiments relate to a computing device comprising: the non-transitory computer-readable storage medium as described herein; and a processor configured to execute the instructions stored in the non-transitory computer-readable storage medium.

### BRIEF DESCRIPTION OF DRAWINGS

The patent or application file contains at least one drawing executed in colour. Copies of this patent or patent application publication with colour drawing(s) will be provided by the Office upon request and payment of the necessary fee.

Various ones of the appended drawings merely illustrate example embodiments of the present disclosure and cannot be considered as limiting in scope.

FIG. 1 is a process flow diagram of a method for editing an image, according to some embodiments;

FIG. 2 is a process flow diagram of a method for generating a mapping, according to some embodiments;

FIGS. 3A and 3B are schematic diagrams of radial warp grids, according to some embodiments;

FIG. 4 is a process flow diagram of a method for determining offset values by adjusting control points, according to some embodiments;

FIG. 5 is a process flow diagram of a method for adjusting control points, according to some embodiments;

FIGS. 6A and 6B are diagrams of example determined and adjusted histograms, according to some embodiments;

FIG. 7 is a process flow diagram of a method for applying a generated mapping to a source image, according to some embodiments;

FIG. 8 is a process flow diagram of an alternative method for applying a generated mapping to a source image, according to some embodiments;

FIGS. 9A to 9D are images which depict various stages of a method for editing an image, according to some embodiments;

FIG. 9E shows stages of an image and its corresponding warp grid being iteratively adjusted, according to some embodiments;

FIG. 10 is a block diagram showing an example system that may be used for image editing, according to some embodiments;

FIG. 11 is a process flow diagram of a method for modifying colour values of a source image to be more similar to colour values of a reference image, according to some embodiments; and

FIG. 12 is a process flow diagram of a method for training a machine learning model to edit an image, according to some embodiments.

### DESCRIPTION OF EMBODIMENTS

Described embodiments relate to systems, methods and computer program products for performing image editing. In particular, described embodiments relate to systems, methods and computer program products for editing attributes of a digital image, such as colour.

Some embodiments provide a method for editing an image that is capable of automatically adjusting attribute values of a source image such that the source image looks similar to another image in some aspect. Image consistency is a desirable feature in image editing as it can be used for ensuring images are on brand and have a certain colour palette that matches brand colours, for ensuring that images fit well to dominant design colours, ensuring that images fit well into a particular image editing style, and for ensuring that multiple images fit well together.

Editing image attributes with existing techniques involves manual adjustment of particular attributes. These manual adjustments are often made at a global level and adjust all the attributes by the same amount, sometimes effecting other attribute values in the process. This can result in undesirable washed images where the attribute being adjusted dominates the entire image. A washed image may occur, for example, when globally adjusting the colours of an image to include more colours of a particular value, such as green, and the image acquires a green overlay as all colour values are shifted towards green. Selecting and adjusting specific attribute values requires separate manual adjustments for each value of each pixel which is time consuming and does not always result in a natural-looking edited image. Adjusting attributes per pixel may result in pixelated sections where borders between pixels become too contrasted. In addition to yielding undesirable results, these methods are time-consuming and tedious for a user to produce an edited image.

Described embodiments may ameliorate some or all of the disadvantages of these existing techniques or provide a useful alternative thereto. Described embodiments, may provide an automated method of editing attributes of digital images, thereby reducing time spent on image editing, as well as improving the resulting image quality of edited images.

In some embodiments, there is a method for editing an image, comprising accessing a source image for editing, and accessing a reference image. The method includes generating a mapping from at least one source attribute value of the source image to a target attribute value. The target attribute values are attribute values that will increase the similarity between the source attribute values and the attribute values of the reference image. The method then includes modifying the source image to generate an edited image by applying the generated mapping to the source image and transforming the source attribute values to the target attribute values. The edited image has at least one attribute value based on the attribute values of the reference image. The method further includes outputting the edited image.

The term “similar” as used herein with reference to a source image and a reference image may refer to having a general likeness in respect of a particular attribute, for example, having a colour palette which is alike. The term similar may additionally refer to general likeness in respect of only one aspect of the images, such as an attribute including colour, brightness, and the like, where the images may vary in other attributes, or to general likeness in respect of more than one or a combination of attributes. The term “similar” may additionally refer to general likeness in some visual aspect between a modified image when compared with a reference image.

The term “closer” as used herein with reference to attribute values may refer to the relationship between two or more attribute values. For example, closer may refer to a comparative relationship between one or more attribute values of the edited image and one or more attribute values of the reference image. Closer may refer to a comparison between the relationship of one or more attribute values of the edited image and the reference image, and the relationship of the one or more attribute values of the edited image and the source image. The term “closer” may be used to indicate that one or more attribute values are within a specified range of, are similar to, are aligned with, are approaching, are proximate to, are converging towards, are within a threshold of, are comparable to, are nearer to or are in the vicinity of one or more other attribute values. The term closer may be used to indicate that one value is within a specified range or within a threshold of another value, for example having a numerical proximity, or having numerical proximity which is less than the numerical proximity previously.

For example, where the proximity between an attribute value of an edited image and an attribute value of a reference image is greater than that of an attribute value of a source image and the attribute value of the reference image, the attribute value of the edited image is said to be closer to the attribute value of the reference image.

Closer may also be used to indicate that an attribute value has greater proximity to one value than another. For example, the attribute value of an edited image may have a greater proximity to the attribute value of the reference image than the proximity it has to the attribute value of the source image, without any particular numerical proximity being specified. Closer may also describe that an attribute value is approaching or converging towards another attribute value, either numerically or positionally. In some embodiments, closer may be used to indicate that the position of a value on a plane or map has moved towards another value. Furthermore, it may be used indicate that one value is comparable to another in some way, for example, numerically, positionally or visually. In some contexts, closer may be used to indicate that one value is nearer to another value than it was previously, or in the vicinity of another value, without specifying exact distances. In some embodiments, closer may be used to refer to a value that appears nearer from an appearance perspective, even if the actual value does not necessarily have numerical proximity. For example, for an attribute value which is a colour value, a purple colour value may be transformed to a maroon colour value.

Although the purple and maroon colour appear visually similar, the numerical values of the colours may not be proximate to one another on a plane or map.

In some examples, closer may refer to a lower comparative difference or distance. For instance, attribute values being closer to attribute values of a reference image may refer to a (first) difference between the attribute values and the attribute values of the reference image being less than a (second) difference between the attribute values and attribute values of the source image. In this regard, difference may refer to a separation, including numerical separation, or distance between attribute values. In some examples this includes a difference, separation or distance in a predefined space, such as a single- or multi-dimensional space, and this may include a space such as a colour space. The colour space may include Lab colour space, and the difference may include a Euclidean distance, for example. In other examples the colour space may include a device-independent colour space, a uniform or perceptually uniform colour space, sRGB, Lab, CIELAB, CIELUV or another colour space described herein. The difference may include any suitable distance, such a geometric distance, a taxicab distance, a cosine distance, a measure of change of visual perception, or another distance described herein. “Less than” can refer to the magnitude or absolute value or square of the first difference having a smaller numerical value than the magnitude or absolute value or square of the second difference. “Less than” can also refer to a normalisation of the first difference or distance having a smaller numerical value than a normalisation of the second difference or distance. In some examples, a “greater proximity” may refer to attributes having a lower comparative difference or distance.

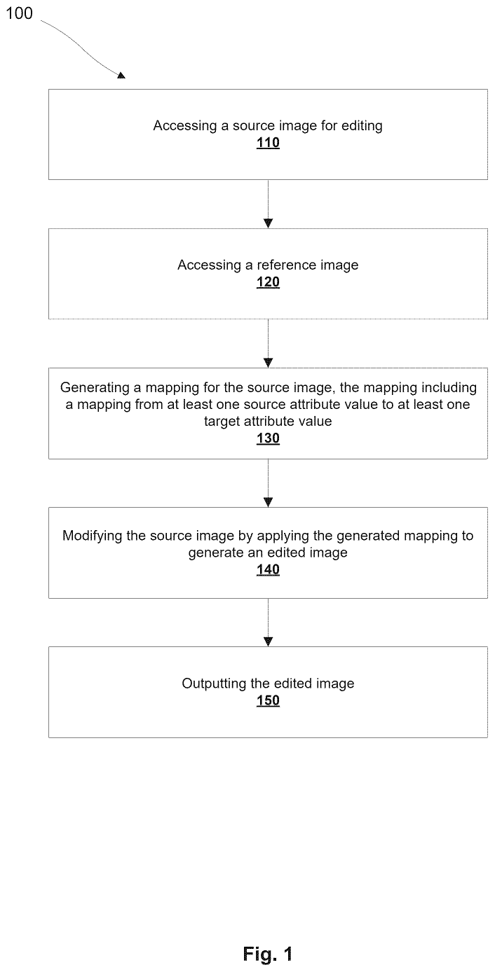

FIG. 1 is a process flow diagram of a method 100 for editing an image, according to some embodiments. The method 100 includes, at 110, accessing a source image for editing. At 120, a reference image is accessed. The reference image provides a reference as to how the source image should be edited. At 130, a mapping is generated for the source image using at least one attribute of the reference image, the mapping including a mapping from at least one source attribute value to a target attribute value.

At 140, the source image is modified by applying the generated mapping to generate an edited image. Finally, at 150, the edited image is output. Outputting the edited image may include storing the editing image to memory. In some embodiments, Outputting the edited image may include transmitting the edited image to a user computing device, or an image editing application.

Referring to step 110 of method 100, the source image is an image to be edited. The source image may be an image file. For example, the source image may be a photo. In some embodiments, the source image may be a plurality of image files. For example, the source image may be a sequence of images, such as in a video file, or an individual frame of a video file. In some embodiments, the source image may be a raster image.

Alternatively, the source image may be a vector image. The source image may be an image having a format including, but not limited to, JPEG, PNG, AVIF, GIF, TIFF, PSD, XCF, EXR, DNG, cr2, HEIC, PDF, SVG and the like. The source image includes one or more attributes.

The method may access the source image for editing by retrieving it from a data store. For example, a source image may be input into a data store for immediate retrieval by the method, or it may be retrieved from a data store which stores a plurality of images after a selection of the source image is received. In some embodiments, the source image may be accessed by extracting the image from a particular location, such as an application, for example, a website or an image storing application. In some embodiments, the source image may be accessed upon receipt of an access request containing information about the source image. The access request may be received from a user of an image editing application.

At 120, the method 100 accesses a reference image. The reference image acts as a guide or reference for how the source image should be edited. The reference image may be used as a reference, guide or target for how the resulting edited image should look. The reference image may also be referred to herein as a target image or a guide image. The source image may be edited to look consistent with a reference image in some aspect. For example, at least one attribute of the source image may be edited to increase similarity to, or reduce the difference between, the corresponding attribute of the reference image. For example, the source image may be edited to look substantially similar in colour or colour palette to the reference image.

The reference image may be an image file. For example, the reference image may be a photo. In some embodiments, the reference image may be an image of a colour palette, or an image which contains a colour palette. The reference image may be a raster image. Alternatively, the reference image may be a vector image. The reference image may be an image having a format including, but not limited to, JPEG, PNG, AVIF, GIF, TIFF, PSD, XCF, EXR, DNG, cr2, HEIC, PDF, SVG and the like. The reference image has one or more attributes.

The method may access the reference image for editing by retrieving it from a data store. A reference image may be input into a data store for immediate access by the method, or it may be accessed from a data store which stores a plurality of images after a selection of the reference image is received. In some embodiments, the reference image may be accessed by extracting the image from a particular location, such as an application, for example, a website or an image storing application.

Accessing the reference image may include receiving the reference image from an input function, for example, the reference image may be uploaded to an image editing application. In some embodiments, the reference image may be accessed after manual or automatic selection of the reference image. For example, the reference image may be manually selected from a plurality of images in a data store. In some embodiments, the reference image may be accessed upon receipt of an access request containing information about the reference image. The access request may be received from a user of an image editing application. Alternatively, the reference image may be accessed by retrieving an input text prompt, such as a colour (e.g. “pink” or “blue”), or a description (e.g. “warm tones” or “cool hues”), wherein the input text prompt is used to generate the reference image. In some embodiments, accessing the reference image may occur through a network or an image editing system.

Attributes refer to characteristics or features of a digital image. In some embodiments, attributes may include one or more of colour, chroma, luminance, brightness, contrast, shadows, saturation, hue, vibrance, highlights, lowlights, and/or chromaticity. In some embodiments, attributes may include an even or uneven combination of other attributes. Attribute values are the values of the specific attribute throughout an image, for example, colour values are the values of the colour attribute which are present throughout an image. Attribute values may be varied depending on the type of image, and/or may have a specific distribution that depends on the makeup of the image. In some embodiments, the attribute values of an image may include the colour values which appear in an image. In some embodiments, the attribute values may include the intensity values which appear in an image. Attribute values may be extracted in the form of value-per-pixel or pixels-per-value. In some embodiments, attribute values include location information, indicating the location of a particular attribute value, for example, the location of pixels within an image that have a particular colour value. Attribute values may be determined at a pixel granularity, or over a defined area of an image, for example, a plurality of pixels. For example, the attribute value of a defined area of an image may be an average of the attribute values of each pixel within the defined area.

Source attribute values are attribute values which are determined from the source image. Source attribute values may be extracted from the source image by performing an analysis and/or extraction process. Similarly, reference attribute values are attribute values which are determined from the reference image. Reference attribute values may be extracted from the reference image by performing an analysis and/or extraction process.

Examples disclosed herein may be made with reference to colour as the attribute being edited in a source image with reference to the colours in a reference image. However, it will be appreciated that various attributes may be edited in a source image using similar methods. One way to make the colour distribution of one image corresponds to, or is similar to, the colour distribution of another image is by making colour distribution histograms of both images more similar to each other. In some embodiments, colour may be represented in a multitude of colour spaces and parameterisations. In some embodiments, colour may be represented in the RGB colour space. However, the RGB colour space entangles luminance with colour information. In some embodiments, where the attribute being edited is only colour (or chroma) information, but not luminance, colour spaces that disentangle luminance from colour may be used. In some embodiments, an HSV colour space may be used. In other embodiments, the OKLab colour space may be used. The OKLab colour space is from the YUV family, with luminance (L) as a separate channel, and “a” and “b” being cartesian coordinates in the chroma plane.

The term “colour” as used herein may refer to chroma, or to chroma and luminance. The term “colour” is intended to broadly encompass any characteristic or combination of characteristics of the image pixels that may be extracted. For example, “colour” may be characterised by one, two or all three of the L, a and b pixel coordinates in an Lab colour space representation, or by one, two, or all three of the red, green, and blue pixel coordinates in an RGB colour space representation, or by one or both of the x and y coordinates of a CIE chromaticity representation or the like. Additionally or alternatively, the colour may incorporate pixel characteristics such as intensity, hue, brightness, and the like. Moreover, while the method is described herein with illustrative reference to two-dimensional images such as photographs or video frames, it will be appreciated that these techniques may be applied to three-dimensional images as well. The term “pixel” as used herein is intended to represent a “picture element” and encompasses image elements of two-dimensional images or of three-dimensional images (which are sometimes also referred to as voxels to emphasise the volumetric nature of the pixels for three-dimensional images.)

At 130, the method 100 generates a mapping that maps at least one source attribute value to a corresponding target attribute value. Target attribute values are attribute values towards which the source attribute values should be shifted. In some embodiments, the target attribute values may be closer to the reference attribute values than the source attribute values. In some embodiments, the target attribute values may be values which move the source attribute values closer to the reference attribute values. In some embodiments, the target attribute values may be the reference attribute values. Each source attribute value of the source image is mapped to a corresponding target attribute value. This mapping is used to transform the source attribute values into the target attribute values. In some embodiments, a source attribute value may be the same as a target attribute value, for example, indicating that there is no change to the attribute value of the source image. In some embodiments, a source attribute value may differ from the target attribute value, indicating that there is a change to the attribute value of the source image.

In some embodiments, the target attribute values may be determined based on the reference image. For example, reference attribute values may be determined from the reference image and used as the target attribute values. In some embodiments, target attribute values may be determined, derived and/or extracted from a representation of the reference attribute values. For example, target values may be determined, derived and/or extracted from a histogram representing the reference attribute values. The representation of the reference attribute values may be used to create the target attribute values. The target attribute values may also be determined on the basis of the source image. For example, the target attribute values may be determined, extracted and/or derived using the reference attribute values, in such a way that they account for the source image attribute values, in order to enable a more natural transformation of the source attribute values in the source image. The target attribute values may be constrained by the attribute values of the source image, or by other constraints. For example, the distance between the target attribute values and the source attribute values may be constrained from being too large. In some embodiments, where the reference image is a colour palette, the reference colour values may be extracted from the colour palette. The target colour values (to which the source colour values should be shifted) may then be calculated using the reference colour values and the source colour values.

The mapping may include mapping information. The mapping information includes assigning each attribute value in a set of source attribute values to a particular attribute value in the set of target attribute values. In some embodiments, the mapping may exclude mapping information where the source attribute value is the same value as the target attribute value. That is, the mapping information may only include source attribute values assigned to target attribute values which are different values. This enables the mapping to apply the transformations to only attribute values which require transformation and leave attribute values which require no transformation.

In some embodiments, generating the mapping may include generating at least one histogram for the source image and/or the reference image. The histogram may represent the distribution of attribute values throughout the source and/or reference image. The histogram may be a 1D histogram. The 1D histogram may include an attribute plane being projected onto a line through the centre, for example, a chroma plane. In some embodiments, multiple 1D histograms may be generated for the source image and/or the reference image. In some embodiments, the histogram is a 2D histogram. The 2D histogram may be generated with a grid of bins in the a/b plane of an Lab colour space. For example, a grid of 64×64 bins may be used.

The source image histogram and/or the reference image histogram may be input into a convolutional neural network (CNN). In some embodiments, the CNN is an encoder. For example, the CNN may define a histogram encoder network. The encoder may be configured to output a source histogram representation from the source image histogram. The encoder may be configured to output a reference histogram representation from the reference image histogram. The source histogram representation and the reference histogram representation may be in the form of embedding vectors. In some embodiments, the source histogram representation and the reference image histogram representation are combined to produce a combined histogram representation. In some embodiments, the source image histogram representation and the reference image histogram representation are concatenated to form a concatenated representation, for example a concatenated vector.

A machine learning model may be configured to generate the mapping. The combined histogram representation may be input into a machine learning model to generate the mapping, and/or a machine learning model may be applied to the combined histogram representation to generate the mapping.

The machine learning model may include any machine learning model, such as, for example, a machine learning model associated with image processing and/or editing. In some embodiments, the machine learning model may include, but is not limited to, logistic regression models, Random Forest models, Naïve Bayes (NB) models, Decision Tree models, Bayesian classifier models, Support Vector Machine (SVM) models, K-Nearest Neighbour (KNN) models, convolutional neural network (CNN) models, artificial neural network (ANN) models, multilayer perceptron (MLP) models, other neural network models, ensemble learning models, and other machine learning and/or deep learning models. In some embodiments, the machine learning model is an artificial neural network (ANN). In some embodiments, the machine learning model is a multilayer perceptron (MLP). In some embodiments, the machine learning model may be trained and/or updated using a supervised learning technique or an unsupervised learning technique. The machine learning model may be trained in accordance with processes and methods disclosed herein.

The machine learning model may be configured to access or receive the combined histogram representation as an input, and output a mapping, or information used to construct a mapping. In some embodiments, the machine learning model has an output in the form of an array. The machine learning model may be configured to determine offset values.

Offset values may be the required offset to shift the source attribute value to the target attribute value. In some embodiments, the offset may be a value representing the difference between the source attribute value and the corresponding target attribute value. In some embodiments, the offset values may be a positional offset, and/or may include a positional offset in an X and/or Y direction of an XY plane. In some embodiments, the machine learning model is configured to determine the offset values between the source attribute values and the target attribute values such that the target attribute values make the source attribute values more similar to the reference attribute values. In some embodiments, the machine learning model determines the offset values based on the combined histogram representation. The offset values between each source attribute value to achieve each corresponding target attribute value may be output by the machine learning model in an offset array. The offset values may be used to construct and/or generate the mapping. That is, the mapping may be generated by using the offset values to determine each target attribute values to which each corresponding source attribute value should be mapped.

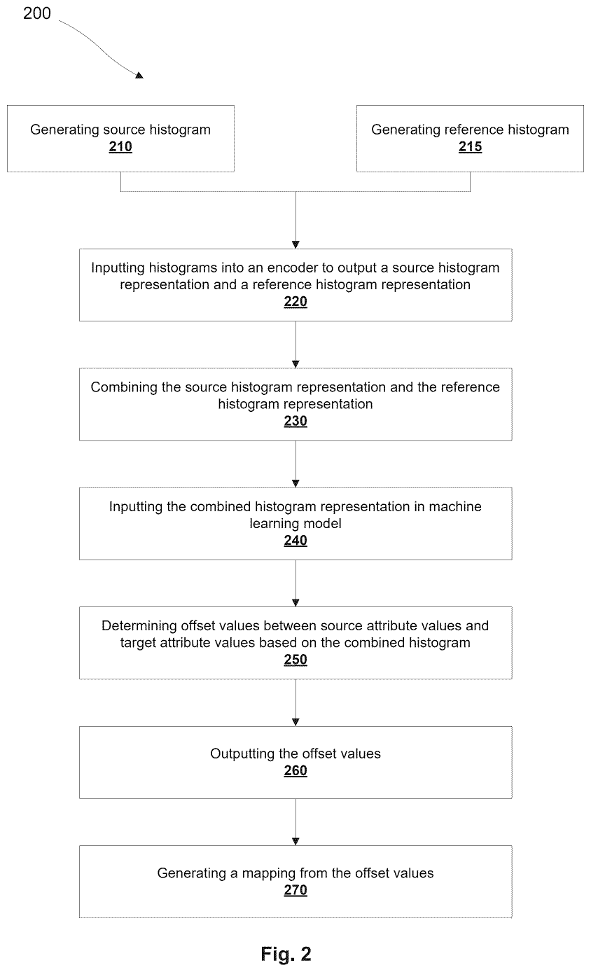

FIG. 2 is a process flow diagram of a method 200 for generating a mapping, according to some embodiments. Method 200 may be performed as part of step 130 of method 100, as described above with reference to FIG. 1. At 210, a source histogram corresponding to the distribution of attribute values in the source image is generated. At 215, a reference histogram corresponding to the distribution of attribute values in the reference image is generated. In some embodiments, 210 and 215 may be performed sequentially or in parallel. The histograms generated in 210 and 215 are then input into an encoder to output a source histogram representation and a reference histogram representation at 220. For example, the histogram representations may be histogram embedding vectors. At 230, the source histogram representation and the reference histogram representation are combined to define a combined histogram representation. The combined histogram representation is then input into a machine learning model at 240. At 250, the machine learning model is applied to the combined histogram representation and the offset value between each source attribute value and the corresponding target attribute value are determined. At 260, the determined offset values are output from the machine learning model, for example, in the form of an offset array. At 270, a mapping is generated from the offset values. In some embodiments, the mapping may be generated by the machine learning model or external to the machine learning model.

The generated mapping may include a data structure. In some embodiments, the data structure may include a map data structure, grid, dictionary, associative array, hash map, a graph data structure, or table data structure. In some embodiments, where adjustments are being made to at least the colour attributes of a source image, mapping may include a lookup table (LUT). In some embodiments, the mapping may include a 3D grid that maps source attribute values to target attribute values. For example, the 3D grid may be a three-dimensional lookup table (3D LUT). The 3D grid may be created using the source attribute values and the reference attribute values and used to output the target attribute values.

The 3D grid may include a warp grid. In some embodiments, the warp grid may be a radial warp grid. The 3D grid may be in the a/b plane of an Lab-type colour space. The a/b plane disentangles chroma information from luma (or brightness) information. The radial warp grid may include an outer ring defined by one or more control points. The control points control the mapping between at least one source attribute value and the at least one target attribute value. In some embodiments, the control points define a peripheral edge of the warp grid. The attribute values of the source image may be initially projected on the warp grid. The control points may then be moved to adjust the source attribute values in such a way that one or more source attribute values map to new values as the control points are moved. In some embodiments, the number of control points in the warp grid is variable and may be a hyperparameter of the machine learning model. In some embodiments, the number of sectors in the warp grid is variable and may be a hyperparameter of the machine learning model.

In some embodiments, the machine learning model is configured to determine the positions of one or more control points such that the source attribute values increase in similarity with the reference attribute values. The machine learning model may take the combined histogram representation and calculate the offset values for each control point on the warp grid in order for the source attribute values to become more similar to the reference attribute values. The offset values can be added to the source attribute values to determine the target attribute values. The offset values may include the X and Y offsets for each of the one or more control points in the warp grid. The machine learning model may be configured to output the target attribute values and/or the determined offset values. In some embodiments, the machine learning model outputs an offset array of the offset values for each of the one or more control points. For example, the machine learning program may output an array with an output dimension of 2*Nₚₒᵢₙₜₛ, where Nₚₒᵢₙₜₛ is the number of control points in the grid. The outputs are the X and Y offsets for each of the control points. The offset array may be used to construct the radial warp grid. The offset values may be used to construct the radial warp grid by using the offset values to shift the initial positions of the control points on a warp grid of the source attribute values to a new position, thereby manipulating the source attribute values on the warp grid and creating a mapping of the source attribute values to their corresponding target attribute values.

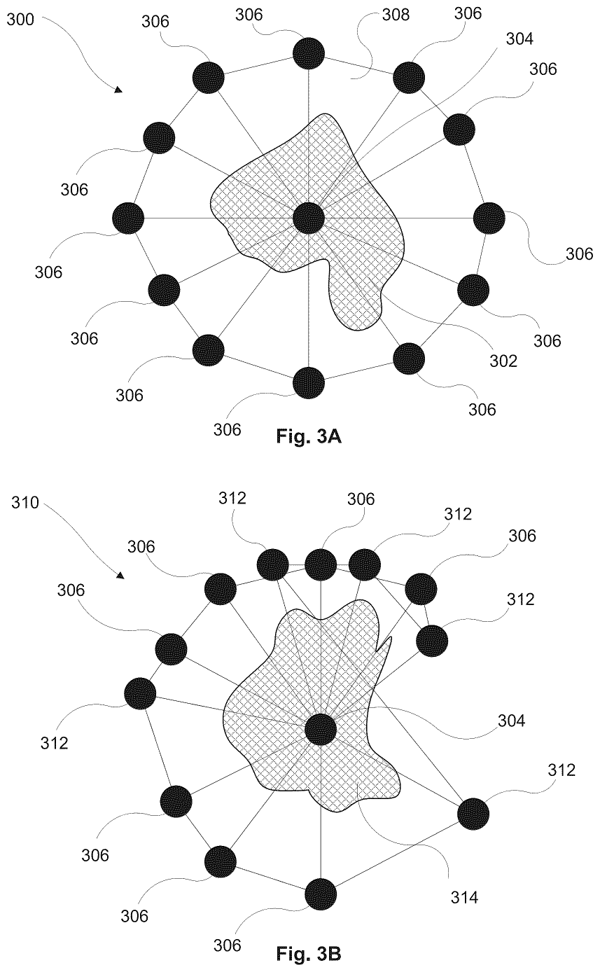

FIGS. 3A and 3B are schematic diagrams of radial warp grids, according to some embodiments. FIG. 3A is a schematic diagram of a radial warp grid 300. Attribute values 302 of a source image are projected onto the grid 300. The grid 300 includes a central control point 304, and peripheral control points 306. One or more sectors 308 may be defined by the number of control points 306 in the radial warp grid 300. FIG. 3B is a schematic diagram of the radial warp grid 300 having been adjusted to make the attribute value projection 302 more similar to a reference image. The adjusted radial warp grid 310 includes adjusted control points 312, which have been moved from the starting position and adjusted the attribute value projection 302 to create an adjusted attribute value projection 314 in the grid 310. The offset between the adjusted control points 312 and their original position defines the offset values. The adjusted control point locations define the target attribute values to which the source attribute values of a source image should be transformed. In some embodiments, the central control point may or may not be adjusted.

In some embodiments, the machine learning model may be configured to iterate over possible control point adjustments to optimise the offset determination. For example, the machine learning model may be configured to perform a method of iteratively adjusting control points until the offset values make the source attribute values more similar to the reference attribute values.

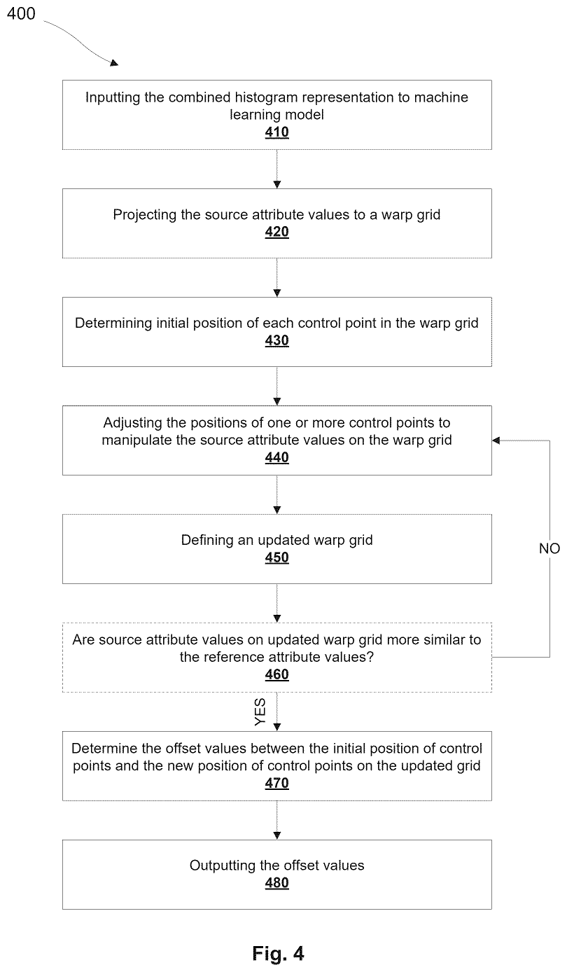

FIG. 4 is a process flow diagram of a method 400 for determining offset values by adjusting control points, according to some embodiments. According to some embodiments, method 400 may be performed as part of step 250 of method 200, as described above with reference to FIG. 2. The method 400 includes, at 410, inputting the combined histogram representation into a machine learning model. At 420, the source attribute values may be projected to a warp grid, for example a radial warp grid, the warp grid having a plurality of control points. At 430, the machine learning model determines the initial positions of each control point. At 440, the machine learning model then adjusts the control points by moving the control points from their initial position to a new position on the warp grid. The adjustment may include moving the control points in the x and y plane. At 450, the method 400 defines an updated warp grid based on adjusted control points. The updated warp grid includes source attribute values which have been manipulated as a result of adjusting the positions of the control points in the warp grid. Then, at 460, the machine learning method determines whether the source attribute values on the updated warp grid are more similar to the reference attribute values. If the source attribute values on the updated warp grid are not more similar to the reference attribute values, then the machine learning model returns to adjusting the positions of one or more control points at 440. 440, 450 and 460 may be repeated one or more times, iteratively adjusting the positions of one or more of the control points each time until the source attribute values are determined to be similar to the reference attribute values. Responsive to determining that the source attribute values are similar to the reference attribute values, offset values between the initial position of each control point and the new position of each control point on the updated warp grid are determined at 470, and the offset values are output at 480.

In some embodiments, 460 may be omitted from method 400, such that method 400 is not caused to iteratively repeat 440, 450 and 460. Method 400 may instead, after adjusting the positions of one or more control points to manipulate the source attribute values on the warp grid at 440 and defining an updated warp grid at 450, proceed directly to 470 to determine the offset values between the initial position of control points and the new position of control points on the updated grid and then output the offset values at 480. That is, the positions of the one or more control points may be adjusted once, for example, by using a trained machine learning model to adjust the control points, before the offset values are determined and output.

In some embodiments, the machine learning model may be configured to perform a method including applying the updated warp grid to a source histogram representation to generate an adjusted histogram representation, and comparing the adjusted histogram representation to the target histogram representation. Responsive to the distance between the adjusted histogram representation and the target histogram representation being below a predetermined threshold, the machine learning model may output the updated warp grid. That is, once the updated warp grid is determined to achieve optimised results to adjust the histogram of the source image to be more similar to a histogram of the reference image, then the updated warp grid defined and output for application to the source image. In embodiments where the distance between the adjusted histogram representation and the target histogram representation are above a predetermined threshold, that is, where it is determined that the updated warp grid has not sufficiently modified the source attribute values to be similar enough to the reference attribute values, the machine learning model may be configured to further adjust the positions of the one or more control points to update the warp grid. In some embodiments, the machine learning model may iteratively repeat the steps of generating an updated warp grid, applying the updated warp grid to the source image histogram and then comparing the adjusted histogram to the reference histogram until the distance between the adjusted histogram representation and the reference histogram representation is below the predetermined threshold.

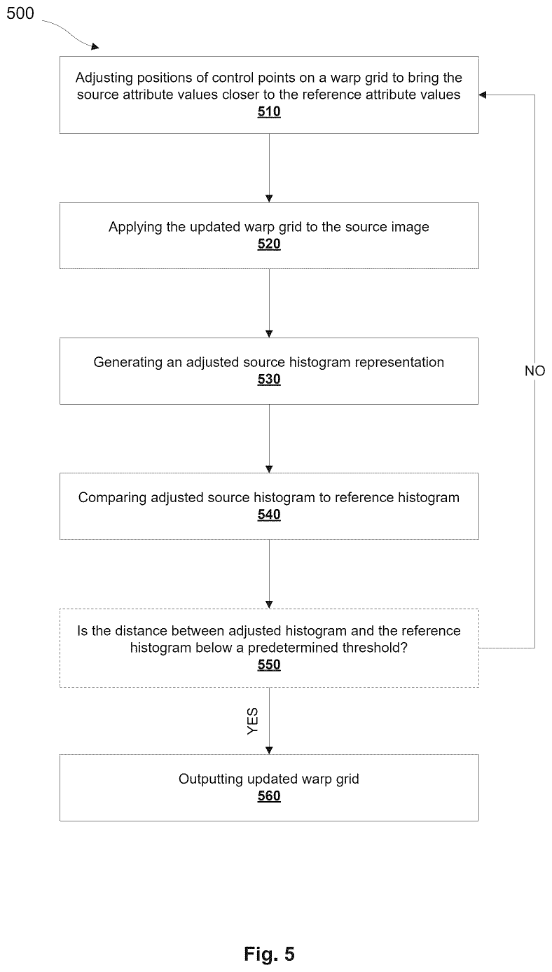

FIG. 5 is a process flow diagram of a method 500 for adjusting positions of control points on a warp grid, according to some embodiments. According to some embodiments, method 500 may be performed as part of step 440 of method 400, as described above with reference to FIG. 4. At 510, the machine learning model adjusts the positions of one or more control points on a warp grid to bring the source attribute values close to the reference attribute values. In some embodiments, adjusting the position of the one or more control points adjusts the X and/or Y positional value of the control point. The change in X and Y values of the position of a control point defines X and Y offset values for the control point. As each of the one or more control points in the warp grid is moved from its original position on the warp grid to a new position, the change in position manipulates the source attribute values to new values that define target attribute values to which the source attribute values may be mapped. The change in position of the one or more control points may define the offset values. At 520, the machine learning model may apply the warp grid to the source image to generate an adjusted source image. An adjusted source histogram is then generated based on the adjusted source image at 530. At 540, the machine learning model compares the adjusted source histogram to a reference histogram corresponding to the reference image.

At 550, the machine learning model determines whether the distance between the adjusted histogram and the reference histogram is below a predetermined threshold. That is, the model determines whether the adjusted histogram is similar to the reference histogram. In some embodiments, this may be determined based on a comparison of distance between histogram vectors. If the distance is determined to be above a predetermined threshold, the machine learning model reverts back to 510 and adjusts the positions of the control points on the warp grid to new positions. Adjusting the positions manipulates the source attribute values closer to the reference values. Responsive to the distance between the adjusted histogram and the reference histogram being below a predetermined threshold, an updated warp grid is output at 560. The updated warp grid is the initial warp grid having the positions of one or more control points adjusted such that when it is applied to the source image, the source attribute values can be mapped to target attribute values similar to the reference attribute values.

In some embodiments, 550 may be omitted from method 500, such that method 500 is not caused to iteratively repeat 510, 520, 530, 540 and 550. Method 500 may include adjusting the control points at 510, applying the updated warp grid to the source image at 520, generating an adjusted source histogram representation at 530, comparing the adjusted source histogram to the reference histogram at 540, and then outputting the updated warp grid at 560. In some embodiments, method 500 may instead, after adjusting the positions of one or more control points on the warp grid to bring the source attribute values closer to the reference attribute values, proceed directly to 560 to output the updated warp grid. That is, the positions of the one or more control points on the warp grid may be adjusted once, for example, by using a trained machine learning model to adjust the control points, before the updated warp grid is output at 560, and may exclude the comparison of histograms performed in 520, 530, and 540.

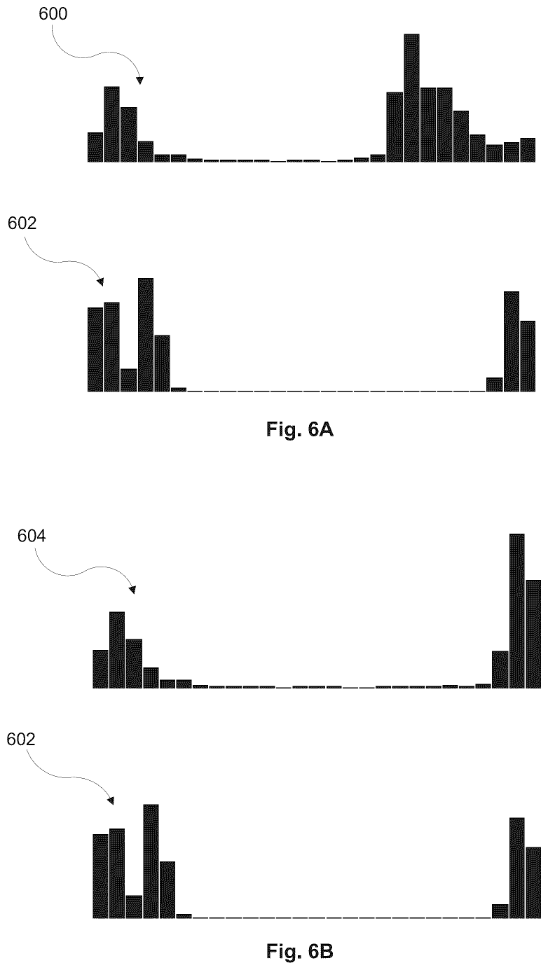

FIGS. 6A and 6B are diagrams of example determined and adjusted histograms, according to some embodiments. FIG. 6A shows a source histogram 600 corresponding to the distribution of colour attribute values in the source image, and a reference histogram 602 corresponding to distribution of colour attribute values in the reference image. As described above, source and reference histograms may be generated at steps 210 and 215 of method 200, as described above with reference to FIG. 2. FIG. 6B shows an adjusted histogram 604, which is the result of applying the updated warp grid to the source histogram 600, as may be performed during step 530 of method 500, as described above with reference to FIG. 5. As can be seen in FIG. 6B, the adjusted source histogram 604 more closely resembles the distribution of colour attribute values in the reference histogram 602 than the source histogram 600 did. The machine learning model may be configured to use the histogram 600, 602, and 604 to adjust the positions of the one or more control points and generate the warp grid. For example, the machine learning model may use the histograms to adjust positions of the one or more control points by comparing the histograms and iteratively adjusting the positions of one or more control points based on the comparison of histograms to determine offset values and optimise the generated mapping, as described above with reference to steps 510 to 550 of method 500.

The predetermined threshold used at step 550 of FIG. 5 may define the distance below which the adjusted histogram representation and the reference histogram representation are determined to be “similar”. The distance between the histograms may indicate whether the target attribute values would bring the source attribute values into better alignment or harmonisation with the reference attribute values. In some embodiments, the distance may be the distance between the histogram vectors. The predetermined threshold may be used to control the level of modification to be applied to the source image. In some embodiments, a higher threshold of similarity may result in more edits, whereas a lower threshold of similarity may result in less edits. The predetermined threshold may be manually defined, or may be automatically defined, for example, the predetermined threshold may be set based on the source image and the reference image. The predetermined threshold may take into account a degree of naturalness to editing attributes, and the predetermined threshold may be set higher or lower depending on the content of the source image, the difference between the source attribute values and the reference attribute values and/or any constraints applied to the mapping generation.

In some embodiments, the use of control points has key technical advantages for image editing. The output from the machine learning model as an array of offset values means that the output sent over a network to an image editing system is extremely compact. In some embodiments, where the resulting image is rendered client side in the browser, the compact output only requires the X and Y offsets of each control point in the grid to construct the mapping. That is, the length of the offset array contains only twice the number of control points from the warp grid (with each control point having an X offset value and a Y offset value). This can be less than 100 bytes. In some embodiments, this enables the mapping to be easily constructed on the client-side once the offset array is received. Additionally, the use of control points in the warp grid enables the incorporation of constraints.

In some embodiments, constraints can be applied to how individual control points behave. In some embodiments, constraints may be introduced in the form of LaGrange multipliers. In some embodiments, constraints may be introduced in the form of loss functions during training. Constraints may be applied when adjusting the positions of control points in step 440 of method 400, or step 510 of method 500. In some embodiments, constraints may be applied in post-processing on the machine learning model's output. For example, the constraints may be applied during the generation or construction of the mapping after the offset values have been received. In some embodiments, the constraints may be applied to the offset values before the warp grid is constructed. In some embodiments, constraints may include, but are not limited to, particular values or ranges of values of one or more attributes not being adjusted (for example, a constraint may include that skin tones which appear in an image shouldn't be adjusted), the distance between two adjacent control points shouldn't get too large (as this could distort the colour transformation too much and lead to artifacts in the result), and the centre point should stay very close to its original position so as to not introduce a global colour shift.

In some embodiments, the constraints may include one or more loss functions. The loss functions may be histogram-based loss functions. In some embodiments, varying histogram-based loss functions may be used. In some embodiments, to smooth histograms and to facilitate gradient flow between neighbouring bins, a histogram may be convolved with a Gaussian kernel. In some embodiments, the histogram loss function may be defined to include the Gaussian convolution.

In some embodiments, I may represent the input, or source image, in Lab colour space, I_{ab} may be the projection of I onto the ab plane, P_{θ}(I_{ab}) may denote the projection of I_{ab} along a line at angle θ through the origin, and Tab and Pe(Tab) may be defined for the target image Tin Lab colour space, which may be, for example, the colour palette reference. The histogram function and the loss function may be defined as follows:

$${H}_{θ}^{I} = histogram ( {P}_{θ} ( {I}_{ab} ) )$$

$${H}_{θ}^{T} = histogram ( {P}_{θ} ( {T}_{ab} ) )$$

$${L}_{hist} = \begin{matrix}{\sum }_{θ ∈ Θ} & {‖ {H}_{θ}^{I} - {H}_{θ}^{T} ‖}_{1}\end{matrix}$$

It will be appreciated that distances other than L1 may also be used, for example L2 may be used. In some embodiments, the histogram loss function may include hue histogram loss and/or saturation histogram loss. In some embodiments, the hue of a colour may be defined as the angle of a point in the ab plane of the Lab colour space. The hue histogram loss captures the distribution of these angles, allowing for the comparison of colour tones between the source and reference (or target) images. One or more hue histogram functions may be defined as:

$${H}_{hue}^{I} = histogram ( {H}^{I} )$$

$${H}_{hue}^{T} = histogram ( {H}^{T} )$$

$${H}_{hue , 180}^{I} = histogram ( {H}_{180}^{I} )$$

$${H}_{hue , 180}^{T} = histogram ( {H}_{180}^{T} )$$

Where H^{I} denotes the hue values of the input source image I, H^{T} denotes the hue values of the target image T,

$${H}_{180}^{I}$$

so is defined as the hue values of the input source image I shifted by 180 degrees, and

$${H}_{180}^{T}$$

is defined as the hue values of the target image T shifted by 180 degrees. The hue loss function may be defined as:

$${L}_{hue} = \frac{1}{2} ( E M D ( {H}_{hue}^{I} , {H}_{hue}^{T} ) + E M D ( {H}_{hue , 180}^{I} , {H}_{hue , 180}^{T} ) )$$

where EMD is Earth Mover's Distance. The hue loss function may use the EMD averaged over both the original hue histograms and those shifted by 180 degrees. This approach may enable the hue distribution of the harmonized image to be correctly aligned with the target palette of the target image, accounting for the wrapping from 360 to 0 degrees.

In some embodiments, saturation may be defined as the distance from the origin in the ab plane of the Lab colour space. In some embodiments, saturation may represent the intensity of purity of a colour. A saturation histogram captures this intensity distribution. One or more saturation histogram functions may be defined as:

$${H}_{sat}^{I} = histogram ( {S}^{I} )$$

$${H}_{sat}^{T} = histogram ( {S}^{T} )$$

Where S^{I} denotes the saturation values of the input source image I, computed as the distance of each point from the origin in the ab plane, and S^{T} denotes the saturation values of the target image T. The saturation loss function may be defined as:

$${L}_{sat} = E M D ( {H}_{sat}^{I} , {H}_{sat}^{T} )$$

The saturation loss function uses the EMD to ensure that the saturation levels in the harmonized image substantially align with those of the target image, preserving the intensity of colours.

In some embodiments, control point constraint losses are configured to help preserve key colours, for example, skin tones in an image, and/or to maintain a particular smoothness in the overall grid deformation. This helps, for example, to prevent similar colours from being mapped to completely different colours, which would show up as ugly artifacts in the resulting image. In some embodiments, the control points are arranged in a radial grid. The grid may be defined such that the central control point, denoted as P₀, is placed at the origin of the ab plane. Further, the grid may be defined such that an even number of surrounding control points, denoted as P₁, P₂, . . . , P_{N} are evenly distributed around P₀ on a unit circle. Further, the control grid may be defined such that the angle between each pair of adjacent control points Pᵢ and Pᵢ₊₁ is equal, ensuring symmetrical placement around the circle.

In some embodiments, to preserve the hue associated with skin tones, an original position loss (OPL) may be used. The OPL penalises deviations of the control point P₁ and its neighbouring points, from their original positions when the control point P₁ is positioned on the skin-tone hue. The original position loss function may be defined as follows:

$${L}_{orig} = {\sum }_{i = 1}^{N} {w}_{i} {‖ {P}_{i} - {P}_{i}^{orig} ‖}_{2}^{2}$$

Where Pᵢ is the current position of the control point i,

$${P}_{i}^{orig}$$

is the original position of the control point i before any transformation, and wᵢ is a weight defined by a Gaussian function centred at P₁, given by:

$${w}_{i} = exp ( - \frac{{{d}_{arc} ( {P}_{i} , {P}_{1} )}^{2}}{2 {σ}^{2}} )$$

Where d_{arc}(Pᵢ, P₁) is the arc distance on the unit circle between points Pᵢ and P₁, and a controls the spread of the Gaussian. The OPL ensures that P₁ remains close to its original position, preserving the skin-tone hue, while allowing points further away on the unit circle to move more freely.

In some embodiments, to prevent control points from exceeding a certain saturation level, a saturation constraint is used. The saturation constraint penalises control points that move beyond the unit circle in the ab plane, where the distance from the origin represents saturation. The saturation constraint loss function may be defined as:

$${L}_{sat} = \frac{1}{N} {\sum }_{i = 1}^{N} max ( 0 , {‖ {P}_{i} ‖}_{2} - 1 )$$

Where Pᵢ is the position of control point i, ∥Pᵢ∥₂ is the Euclidean distance of Pᵢ from the origin (i.e., the saturation of Pᵢ), and the term max (0, ∥Pᵢ∥₂−1) represents the Rectified Linear Unit (ReLU) function applied to the distance, ensuring that only points exceeding the unit distance (saturation level) are penalised. The saturation constraint loss function encourages all control points to stay within the unit circle, effectively preventing them from exceeding their original saturation, using an L1 norm to measure the penalty.

In some embodiments, in addition to preventing control points from exceeding the unit circle, a constraint to prevent saturations from deviating from 1 may also be used. This constraint, the saturation deviation loss, penalises deviations of the control points saturation from the unit value. The saturation deviation loss function is defined as:

$${L}_{sat - dev} = \frac{1}{N} {\sum }_{i = 1}^{N} {( {‖ {P}_{i} ‖}_{2} - 1 )}^{2}$$

Where Pᵢ is the position of control point i, and ∥Pᵢ∥₂ is the Euclidean distance of Pᵢ from the origin (i.e., the saturation of Pᵢ), where this term penalises any deviation from a saturation of 1, encouraging all control points to maintain a saturation close to the unit value. The saturation deviation loss is an L2 loss that ensures that the control points remain close to the unit circle, preventing them from either shrinking inward or expanding outward significantly.

In some embodiments, to formulate loss functions that account for the relationship between neighbouring control points, the neighbours for each control point may be defined by, for each control pint, Pᵢ where i∈{1, 2, . . . , N}:
Pᵢ₍ᵢ₎ denotes the left neighbour of Pᵢ, defined as:

$$l ( i ) = \{ N if i = 1 i - 1 if i > 1$$

Pᵣ₍ᵢ₎ denotes the right neighbour of Pᵢ defined as:

$$r ( i ) = \{ 1 if i = N i + 1 if i < N$$

With the above definitions, each control point Pᵢ has two neighbours: Pᵢ₍ᵢ₎ on its left and Pᵣ₍ᵢ₎ on its right. These relationships will be used in the loss functions described herein to ensure consistency and smooth transitions between neighbouring points.

In some embodiments, to ensure that the relative distances between neighbouring control points don't get too extreme during the transformation, an original neighbour distance (OND) loss may be used. The OND loss penalises deviations in the distances between each control point and its neighbours compared to their original distances. The OND loss function may be defined by:

$${L}_{neigh} = \frac{1}{N} {\sum }_{i = 1}^{N} [ {( {‖ {P}_{i} - {P}_{l ( i )} ‖}_{2} - {‖ {P}_{i}^{orig} - {P}_{l ( i )}^{orig} ‖}_{2} )}^{2} + {( {‖ {P}_{i} - {P}_{r ( i )} ‖}_{2} - {‖ {P}_{i}^{orig} - {P}_{r ( i )}^{orig} ‖}_{2} )}^{2} ]$$

Where Pᵢ is the current position of control point i,

$${P}_{i}^{orig}$$

is the original position of control point i before any transformation, Pᵢ₍ᵢ₎ and Pᵣ₍ᵢ₎ are the left and right neighbours of Pᵢ respectively, ∥Pᵢ−P₁₍ᵢ₎∥₂ is the Euclidean distance between Pᵢ and its left neighbour P₁₍ᵢ₎ in the current configuration,

$${‖ {P}_{i}^{orig} - {P}_{l ( i )}^{orig} ‖}_{2}$$

is the Euclidean distance between

$${P}_{i}^{orig}$$

and its original left neighbour

$${P}_{l ( i )}^{orig} ,$$

∥Pᵢ−Pᵣ₍ᵢ₎∥₂ is the Euclidean distance between Pᵢ and its right neighbour Pᵣ₍ᵢ₎ in the current configuration, and

$${‖ {P}_{i}^{orig} - {P}_{r ( i )}^{orig} ‖}_{2}$$

is the Euclidean distance between

$${P}_{i}^{orig}$$

and its original right neighbour

$${P}_{r ( i )}^{orig} .$$

The OND loss function is an L2 loss that ensures that the distances between neighbouring control points do not deviate significantly from their original configuration, contributing to the smoothness of the control point grid.

In some embodiments, to maintain consistent spacing between consecutive control points, a neighbour distance difference (NDD) loss is used. The NDD loss penalises differences in the distances between consecutive control points, ensuring that the spacing remains uniform. In some embodiments, dᵢ may be defined as the distance between consecutive control points Pᵢ and Pᵢ₊₁, such that:

$${d}_{i} = {‖ {P}_{i} - {P}_{i + 2} ‖}_{2}$$

Where P_{N+1}=P₁ to maintain the circular structure.

The NDD loss function may then be defined as:

$${L}_{neigh - diff} = \frac{1}{N} {\sum }_{i = 1}^{N} \vert {d}_{i} - {d}_{i + 1} \vert$$

Where dᵢ=∥Pᵢ−Pᵢ₊₁∥₂ is the Euclidean distance between consecutive control points Pᵢ and Pᵢ₊₁, and the term |dᵢ−dᵢ₊₁| penalises differences between consecutive distances. The NDD loss is an L1 loss that ensures that the difference in spacing between consecutive control points is minimised, promoting uniformity in the distribution of control points around the unit circle.

In some embodiments, to ensure that the angular relationships between consecutive control points remain consistent, an angle difference loss may be used. The angle difference loss penalises variations in the angles formed between each control point and its neighbours promoting uniform angular spacing. In some embodiments, θᵢ may be defined as the angle between the vectors Pᵢ→Pᵢ₍ᵢ₎ and Pᵢ→Pᵣ₍ᵢ₎, such that:

$$cos cos ( {θ}_{i} ) = \frac{( {P}_{l ( i )} - {P}_{i} ) \cdot ( {P}_{r ( i )} - {P}_{i} )}{{‖ {P}_{l ( i )} - {P}_{i} ‖}_{2} \cdot {‖ {P}_{r ( i )} - {P}_{i} ‖}_{2}}$$

Where Pᵢ₍ᵢ₎ is the left neighbour of Pᵢ, and Pᵣ₍ᵢ₎ is the right neighbour of Pᵢ. The angle difference loss function may be defined as:

$${L}_{angle - diff} = \frac{1}{N} {\sum }_{i = 1}^{N} \vert cos cos ( {θ}_{i} ) - cos cos ( {θ}_{i + 1} ) \vert$$

Where θᵢ is the angle formed between the vectors Pᵢ→Pᵢ₍ᵢ₎ and Pᵢ−Pᵣ₍ᵢ₎, and the term |cos cos (θᵢ)−cos cos (θᵢ₊₁)| penalises differences in the cosine of the angle between consecutive control points. The angle difference loss is an L1 loss that ensures that the angles between consecutive control points remain similar, promoting smooth angular transitions.

In some embodiments, to maintain consistent saturation levels between consecutive control points, we introduce the neighbour saturation difference (NSD) loss. The NSD loss penalises differences in the saturation between neighbouring control points, promoting uniform saturation across the grid. In some embodiments, sᵢ may be defined as the saturation (distance from the origin) of control point Pᵢ, such that:

$${s}_{i} = {‖ {P}_{i} ‖}_{2}$$

Where ∥P∥₂ is the Euclidean distance of Pᵢ from the origin, representing the saturation of the control point. The NSD loss function may be defined as:

$${L}_{sat - diff} = \frac{1}{N} {\sum }_{i = 1}^{N} \vert {s}_{i} - {s}_{i + 1} \vert$$

Where sᵢ=∥Pᵢ∥₂ is the saturation of control point Pᵢ, the term |sᵢ−sᵢ₊₁| penalises differences in saturation between consecutive control points, and P_{N+1}=P₁ to maintain the circular structure. The NSD loss is an L1 loss that ensures the saturation levels between consecutive control points remain similar, promoting uniform saturation and avoiding abrupt changes in colour intensity across the grid.

In some embodiments, to ensure that the hues of the control points are preserved during transformation, a hue preservation loss may be used. The hue preservation loss measures the mean sine of the angle between the vectors corresponding to the original (source) and transformed (target) points. In some embodiments,

$${P}_{i}^{orig}$$

may be the original position of control point Pᵢ, and Pᵢ may be the transformed position. The angle θᵢ between these two vectors is given by:

$$sin sin ( {θ}_{i} ) = \frac{{‖ {P}_{i}^{orig} \times {P}_{i} ‖}_{2}}{{‖ {P}_{i}^{orig} ‖}_{2} \cdot {‖ {P}_{i} ‖}_{2}}$$

Where × denotes the cross product of the two vectors. The hue preservation loss function may be defined as:

$${L}_{hue - pres} = \frac{1}{N} {\sum }_{i = 1}^{N} sin sin ( {θ}_{i} )$$

Where

$${P}_{i}^{orig}$$

is the original position of control point Pᵢ, Pᵢ is the transformed position of control point Pᵢ, sin sin (θᵢ) measures the sine of the angle between the original and transformed vectors for each control point. The hue preservation loss takes the mean of these sine values to penalise deviations in hue. The hue preservation loss function ensures that the hue (directional angle) of each control point is preserved as closely as possible during transformation by minimising the angle between the original and transformed vectors.

In some embodiments, to maintain the relative angular positioning (hue) between neighbouring control points, a hue difference loss is used. The hue difference loss penalises deviations in the angular difference between neighbouring control points compared to their original angular differences. In some embodiments,

$${α}_{i}^{orig}$$

may be defined as the original angular difference between neighbouring control points Pᵢ and Pᵢ₊₁, and αᵢ may be defined as the angular difference after transformation. These angles may be given by:

$${α}_{i}^{orig} = ∠ ( {P}_{i}^{orig} , {P}_{i + 1}^{orig} )$$

$${α}_{i} = ∠ ( {P}_{i} , {P}_{i + 1} )$$

Where <(Pᵢ, Pᵢ₊₁) denotes the angle between the vectors corresponding to control points Pᵢ and Pᵢ₊₁. The hue difference loss function may be defined as:

$${L}_{hue - diff} = \frac{1}{N} {\sum }_{i = 1}^{N} \vert {a}_{i} - {a}_{i}^{orig} \vert$$

Where

$${α}_{i}^{orig} = ∠ ( {P}_{i}^{orig} , {P}_{i + 1}^{orig} )$$

is the original angular difference between control points Pᵢ and Pᵢ₊₁, αᵢ=<(Pᵢ, Pᵢ₊₁) is the angular difference after transformation, the term

$$\vert {α}_{i} - {a}_{i}^{orig} \vert$$

represents the L1 loss that penalises deviations in the angular difference, and P_{N+1}=P₁ to maintain the circular structure. The hue difference loss is an L1 loss that ensures the angular differences (hue differences) between neighbouring control points remain consistent with their original configuration, preserving the relative hue relationships across the grid.

Referring back to FIG. 1, the method 100, at 140, includes modifying the source image to generate an edited image by applying the generated mapping. The edited image has at least one attribute value based on the attribute values of the reference image. In some embodiments, the edited image may have attribute values closer to the reference image than the source image. That is, the edited image has attribute values which have moved towards the attribute values of the reference image. Modifying the source image may include applying the generated mapping to the source image such that the attribute values of the source image are transformed into the corresponding target attribute values defined in the mapping. In some embodiments, applying the generated mapping to the source image includes transforming the attribute value of each pixel of the source image to the target attribute values defined in the generated mapping. In some embodiments, modifying the image may increase the similarity and/or reduce the difference between attribute values of the source image and the reference image.

In some embodiments, modifying the source image by applying the generated mapping at 140 of method 100 may comprise processing the source attribute value and determining that it corresponds to a particular position within the grid. In some embodiments, the position may correspond to a voxel in the grid. The value at that position in the grid corresponds to a new adjusted attribute value, resulting in an output of a target attribute value that corresponds to, or is shifted towards, the reference attribute value. In some embodiments, the grid may process a colour value, and determine that it corresponds to a particular position within the grid. The values at that position in the grid determine the output colour, resulting in a target colour value that corresponds to, or is shifted towards, the reference colour value. In some embodiments, the target attribute value may be derived using trilinear interpolation based on the values at the corner of the voxel corresponding to the position in the 3D grid.

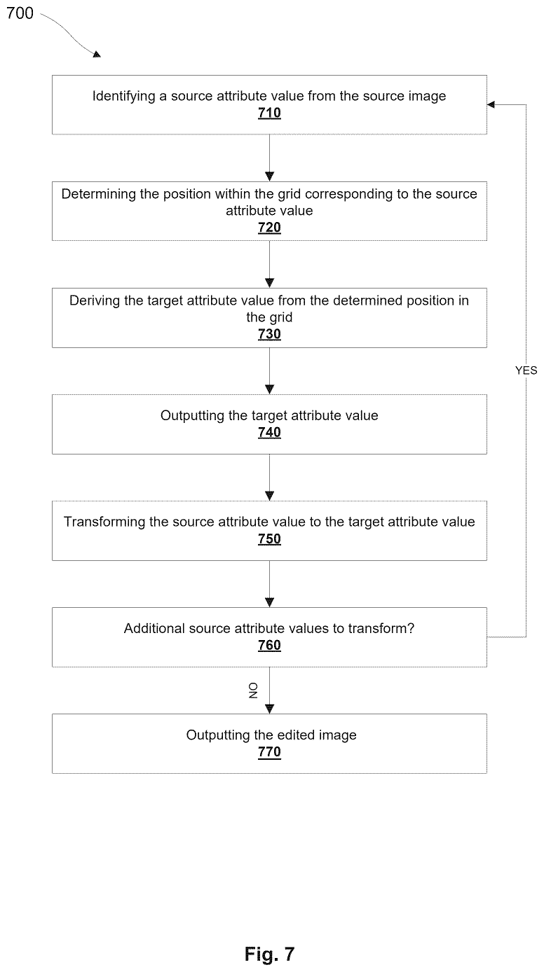

FIG. 7 is a process flow diagram of a method 700 for applying a generated mapping to a source image, according to some embodiments. Method 700 may be performed as part of step 140 of method 100, as described above with reference to FIG. 1. Method 700 is a method in which each individual source attribute values is modified sequentially. At 710, a source attribute value from the source image is identified. The position within the grid that corresponds to the source attribute value is then determined at 720. At 730, the target attribute value is derived from the determined position in the grid. At 740, the derived target attribute value is output. At 750, using the output target attribute value, the source attribute value is transformed to the target attribute value. At 760, it is the determined whether there are further source attribute values in the source image to be transformed based on the mapping. Responsive to there being additional source attribute values to transform, the method 700, reverts to 710 to identify a new source attribute value. Responsive to there being no further source attribute values to transform, that is, where all source attribute values in the source image have been transformed to their corresponding target attribute values, an edited image is output at 770. Therefore, by applying the generated mapping, the source image is modified to generate an edited image.

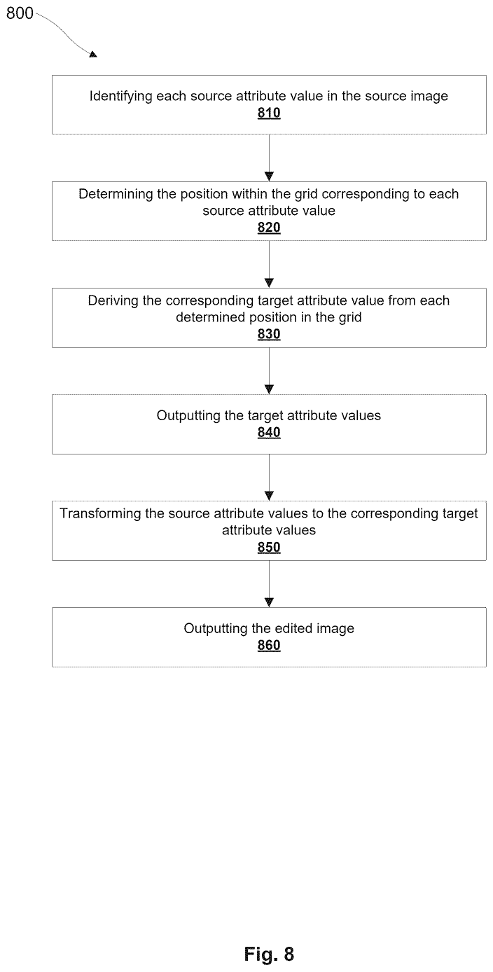

FIG. 8 is a process flow diagram of an alternative method 800 for applying a generated mapping to a source image, according to some embodiments. Method 800 may be performed as part of step 140 of method 100, as described above with reference to FIG. 1. Method 800 is a method in which all source attribute values of the source image are modified at the same time. At 810, each source attribute value from the source image is identified. The position within the grid that corresponds to each source attribute value is then determined at 820. At 830, the corresponding target attribute values are derived from each determined position in the grid. At 840, the derived target attribute values are output. At 850, using the output target attribute values, the source attribute values are transformed to their corresponding target attribute values. All source attributes values are therefore transformed to new attribute values, modifying the source image. At 860, an edited image is output. A combination of methods 700 and 800 may be used as part of step 140 in method 100. In some embodiments, where attribute values are similar, such as having similar shades of colour, attribute values may be grouped together. Method 800 may be used to modify a group of similar attribute values simultaneously, and method 700 may be used to step through a plurality of groups to modify each group sequentially.

Once the generated mapping has been applied to the source image, and the source attribute values transformed to the target attribute values, the edited image will have attribute values such that it visually appears more similar to the reference image in at least some aspect.

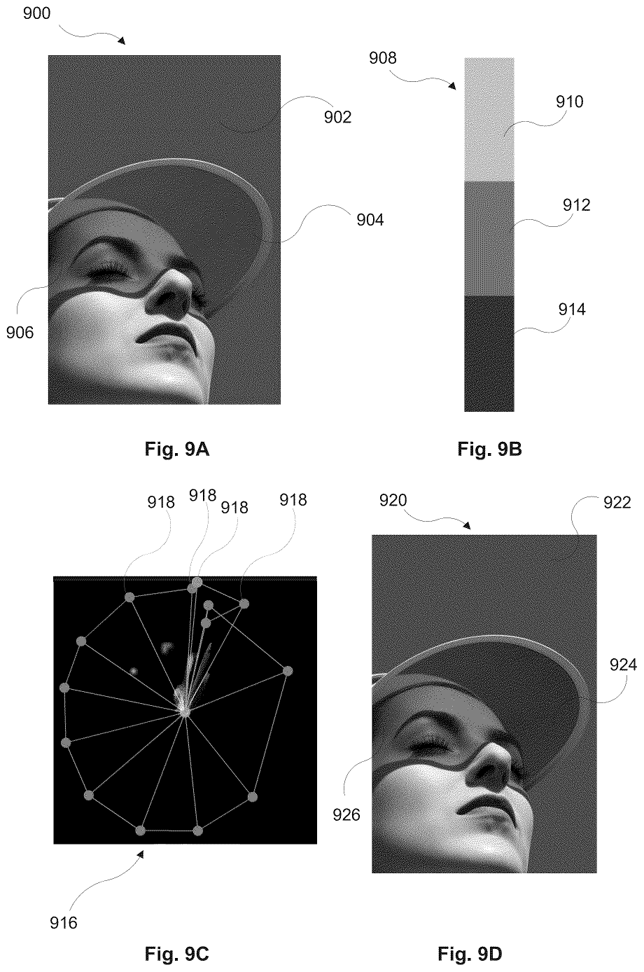

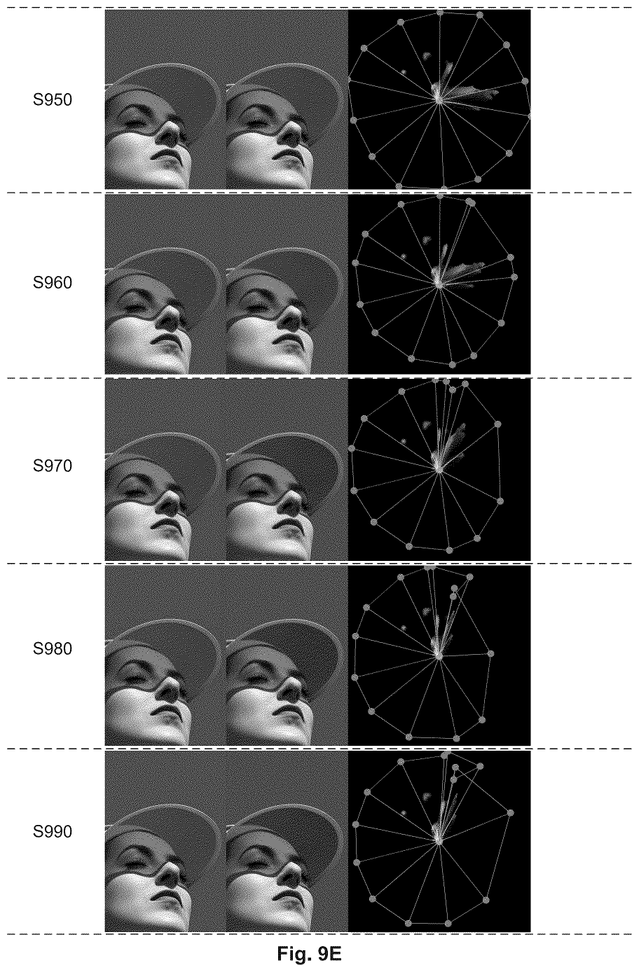

FIGS. 9A to 9D are images which depict various stages of a method for editing an image, according to some embodiments. FIG. 9A depicts an example source image 900 which may be accessed for editing. The source image 900 has predominately purple and blue colours, including a purple background 902, a purple visor, 904, and a purple shadow 906. FIG. 9B depicts an example reference image 908, which is a colour palette including yellow 910, orange 912, and red 914 colours. FIG. 9C is an example generated mapping in the form of a radial warp grid 916, which has offset a subset of control points 918 to map the purple and blue colour values of the source image 900 to yellow 910, orange 912, and red 914 colours which appear in the reference image 908. FIG. 9D is an edited image 920, generated by applying the mapping of the radial warp grid 916 to the source image 900. The edited image 920 now includes a red background 922, a red visor 924 and a red shadow 926.

FIG. 9E shows stages of an image and its corresponding warp grid being iteratively adjusted, according to some embodiments. In each stage, the source image 900 is shown on the left of the images for comparison, an edited image is shown in the centre, and a radial warp grid corresponding to the edited image is shown on the left. The source image 900 starts in its original form at S950, with the edited image of S950 being the same as the source image 900. The radial warp grid for the source image 900 is shown on the left. As the method iteratively adjusts the control points of the warp grid between each stage, the source image 900 is adjusted towards the reference image 908 shown in FIG. 9B. As FIG. 9E progresses through stages S960, S970, S980 and S990, the radial warp grid is iteratively adjusted, resulting in a changing colour palette for the edited image in the centre. As can be seen in FIG. 9E, from stages S950 to S990, the central image gradually adjusts from the source image 900 to edited image 920 such that its colour attributes are more in line with the reference image 908. At each iteration, the similarity between the edited image and the reference image 908 may be evaluated and/or compared to determine whether further adjustments of the radial warp grid are required.

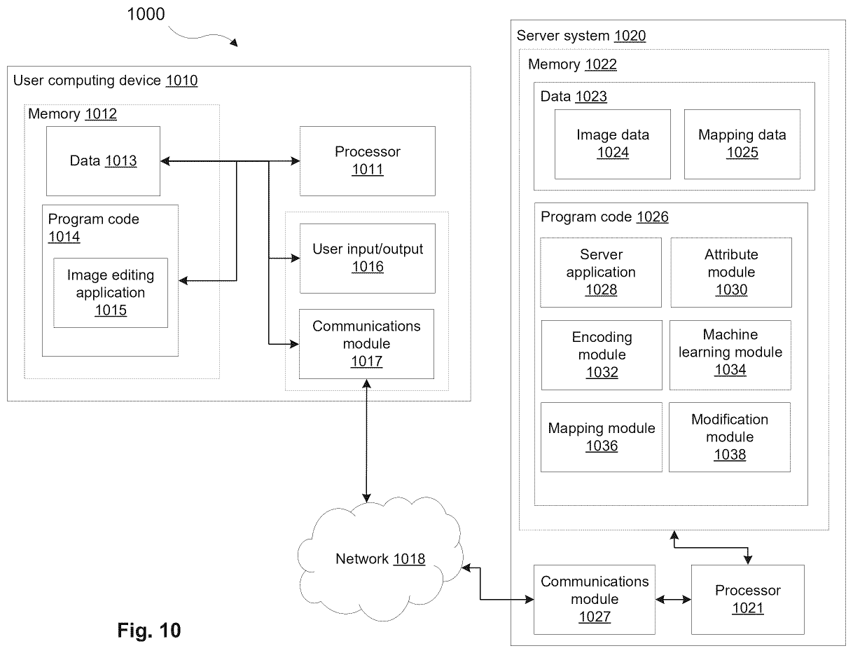

FIG. 10 is a block diagram showing an example system 1000 that may be used for image editing, according to some embodiments. System 1000 comprises a user computing device 1010 which may be controlled by a user wishing to edit one or more images. In the illustrated embodiment of FIG. 10, system 1000 further comprises a server system 1020. User computing device 1010 may be in communication with server system 1020 via a network 1018. However, in some embodiments, user computing device 1010 may be configured to perform the described methods independently, without access to a network 1018 or server system 1020.

User computing device 1010 may be a computing device such as a personal computer, laptop computer, desktop computer, tablet, or smart phone, for example. User computing device 1010 comprises a processor 1011 configured to read and execute program code. Processor 1011 may include one or more data processors for executing instructions, and may include one or more of a microprocessor, microcontroller-based platform, a suitable integrated circuit, and one or more application-specific integrated circuits (ASICs).

User computing device 1010 further comprises at least one memory 1012. Memory 1012 may include one or more memory storage locations which may include volatile and non-volatile memory, and may be in the form of ROM, RAM, flash or other memory types. Memory 1012 may also comprise system memory, such as a BIOS.

Memory 1012 is arranged to be accessible to processor 1011, and to store data that can be read and written to by processor 1011. Memory 1012 may also contain program code 1014 that is executable by processor 1011, to cause processor 1011 to perform various functions. For example, program code 1014 may include an image editing application 1015. Processor 1011 executing image editing application 1015 may be caused to perform the methods disclosed herein, such as one or more steps of methods 100, 200, 400, 500, 700, 800, 1100 and/or 1200.

According to some embodiments, image editing application 1015 may be a web browser application (such as Chrome, Safari, Internet Explorer, Edge, Opera, or any other alternative web browser application) which may be configured to access web pages that provide image editing functionality via an appropriate uniform resource locator (URL).

Program code 1014 may include additional applications that are not illustrated in FIG. 10, such as an operating system application, which may be a mobile operating system if user computing device 1010 is a mobile device, a desktop operating system if user computing device 1010 is a desktop device, or an alternative operating system. User computing device 1010 may further comprise user input and output peripherals 1016. These may include one or more of a display screen, touch screen display, mouse, keyboard, speaker, microphone, and camera, for example. User I/O 1016 may be used to receive data and instructions from a user, and to communicate information to a user.

User computing device 1010 may further comprise a communications module 1017, to facilitate communication between user computing device 1010 and other remote or external devices. Communications module 1017 may allow for wired or wireless communication between user computing device 1010 and external devices, and may use Wi-Fi, USB, Bluetooth, or other communications protocols. According to some embodiments, communications module 1017 may facilitate communication between user computing device 1010 and server system 1020 via a network 1018, for example.

Network 1018 may comprise one or more local area networks or wide area networks that facilitate communication between elements of system 1000. For example, according to some embodiments, network 1018 may be the internet. However, network 1018 may comprise at least a portion of any one or more networks having one or more nodes that transmit, receive, forward, generate, buffer, store, route, switch, process (or any combination thereof), one or more messages, packets, signals, and/or some combination thereof. Network 1018 may include, for example, one or more of a wireless network, a wired network, an internet, an intranet, a public network, a packet-switched network, a circuit-switched network, an ad hoc network, an infrastructure network, a public-switched telephone network (PSTN), a cable network, a cellular network, a satellite network, a fibre-optic network, and/or some combination thereof.

Server system 1020 may comprise one or more computing devices and/or server devices (not shown), such as one or more servers, databases, and/or processing devices in communication over a network, with the computing devices hosting one or more application programs, libraries, APIs or other software elements. The components of server system 1020 may provide server-side functionality to one or more client applications, such as image editing application 1015. The server-side functionality may include operations such as user account management, login, and content creation functions such as image editing, saving, publishing, and sharing functions. According to some embodiments, server system 1020 may comprise a cloud-based server system.

While a single server system 1020 is shown, server system 1020 may comprise multiple systems of servers, databases, and/or processing devices. Server system 1020 may host one or more components of a platform for performing image editing according to some described embodiments.

Server system 1020 may comprise at least one processor 1021 and a memory 1022. Processor 1021 may include one or more data processors for executing instructions, and may include one or more of a microprocessor, microcontroller-based platform, a suitable integrated circuit, and one or more application-specific integrated circuits (ASIC's). Memory 1022 may include one or more memory storage locations, and may be in the form of ROM, RAM, flash or other memory types.

Memory 1022 is arranged to be accessible to processor 1021, and to contain data 1023 that processor 1021 is configured to read and write to. Data 1023 may store data such as user account data, image data (including source image data and reference image data), mapping data and data relating to image editing tools, such as machine learning models trained to perform image editing functions.

In the illustrated embodiment of FIG. 10, data 1023 comprises image data 1024 and mapping data 1025. Image data 1024 may store source image data relating to an image to be edited by image editing application 1015. Image data 1024 may be determined, retrieved or accessed from user computing device 1010 executing image editing application 1015 in response to a user selecting or uploading an image to be edited. Image data 1024 may include reference image data that may be determined, retrieved or accessed from user computing device 1010 in response to a user providing or inputting a reference image while executing image editing application 1015, in order to perform an image editing function. Image data 1024 may include data related to source images and reference images, including data relating to attribute values of source images and reference images, and histograms related to source images and reference images. Mapping data 1025 may include mappings and data related to mappings, including data used to construct mappings, including target attribute values, grids, logs of control point adjustments and offset values. While these are illustrated as residing in memory 1022 of server system 1020, in some embodiments some or all of this data may alternatively or additionally reside in memory 1012 of user computing device 1010, or in an alternative local or remote memory location.

Memory 1022 further comprises program code 1026 that is executable by processor 1021, to cause processor 1021 to execute workflows. In some embodiments, program code 1026 comprises a server application 1028 executable by processor 1021 to cause server system 1020 to perform server-side functions. According to some embodiments, such as where image editing application 1015 is a web browser, server application 1028 may comprise a web server such as Apache, IIS, NGINX, GWS, or an alternative web server. In some embodiments, the server application 1028 may comprise an application server configured specifically to interact with image editing application 1015. Server system 1020 may be provided with both web server and application server modules.

Program code 1026 may also comprise one or more code modules, such as one or more of an attribute module 1030, an encoding module 1032, a machine learning module 1034, a mapping module 1036, and a modification module 1038. In some embodiments, the mapping module 1036 may form part of the machine learning module 1034. In some embodiments, the machine learning module may include a training module (not shown) configured to train machine learning models that may be applied or utilised by the machine learning module. The encoding module 1038 may include a neural network, for example, in the form of a CNN. Processor 1021 executing code modules of program code 1026 may be caused to perform the methods disclosed herein, such as one or more steps of methods 100, 200, 400, 500, 700, 800, 1100 and/or 1200.

Executing attribute module 1030 may cause processor 1021 to perform an attribute determination process on an image to be edited. In some embodiments, executing attribute module 1030 may cause processor 1021 to perform one or more of steps 110 and/or 120 of method 100, steps 210 and/or 215 of method 200, steps 1110, 1111, 1112, 1113, 1114, and/or 1115 of method 1100, steps 1210, 1211, 1212, and/or 1213 of method 1200. According to some embodiments, processor 1021 executing attribute module 1030 may be caused to access a source image to be edited and extract attribute values relating to an attribute of the source image to be edited. Similarly, the attribute module 1030 may be caused to extract attribute values relating to an attribute of a reference image. The attribute module may be configured to determine, retrieve or access an attribute selection, for example, based on user input, such as a user selected attribute. In some embodiments, the attribute selection may be automatically identified, for example, based on the reference image. In one example, where the reference image is a colour palette, the attribute module 1030 may determine that the attribute to be edited is colour. The attribute module 1030 may execute the extraction of attribute values from the source image and/or the reference image and store the attribute values in image data 1024. In some embodiments, the attribute module 1030 may be configured to generate distribution histograms of the attribute values extracted from a source and/or a reference image. These may also be stored in image data 1024.

Executing encoding module 1032 may cause processor 1021 to perform an encoding or embedding process on an input, such as a generated source image histogram or reference image histogram. In some embodiments, executing encoding module 1032 may cause processor 1021 to perform one or more of steps 220 and/or 230 of method 200, step 530 of method 500, steps 1116, 1117, and/or 1118 of method 1100, and steps 1214, 1215, and/or 1216 of method 1200. The encoding module 1032 may include a CNN configured to transform generated histograms from the image data 1024 into histogram embedding vectors. For example, the encoding module 1032 may be caused to generate a histogram representation from the histograms generated by the attribute module 1030. The representation may be a lower-dimensional representation of the input that may be interpretable by the machine learning module 1034. In some embodiments, the encoding module 1032 may be configured to combine a source histogram representation and a reference histogram representation into a combined histogram representation. For example, the encoding module 1032 may concatenate a source histogram embedding vector and a reference histogram embedding vector into a concatenated vector. The encoding module 1032 may be configured to output one or more histogram embedding vectors or combined histogram embedding vectors to the machine learning module 1034.

Executing machine learning module 1034 may cause processor 1021 to apply a trained machine learning model to the combined histogram representation. In some embodiments, executing machine learning module 1034 may cause processor 1021 to perform one or more of steps 240, 250 and/or 260 of method 200, steps 410, 420, 430, 440, 450, 460, 470 and/or 480 of method 400, steps 510, 520, 530, 540, 550, and/or 560 of method 500, step 1120 of method 1100, and/or step 1218 of method 1200. The machine learning module 1034 may be configured to generate a mapping by determining one or more control points for the mapping, the control points controlling mapping between at least one source attribute value and at least one target attribute value. The machine learning module 1034 may be configured to determine offsets for each of the one or more control points and output an offset array of the offset values for each of the one or more control points. The offset values include X and Y offsets for each of the one or more control points. The machine learning module 1034 may output the offset array directly to the mapping module 1036.

Executing mapping module 1036 may cause processor 1021 to perform a mapping generation process. In some embodiments, executing mapping module 1036 may cause processor 1021 to perform one or more steps of 130 of method 100, 270 of method 200, step 1122 of method 1100, and 1220 of method 1200. The mapping module 1036 may be configured to receive or access the offset array output from the machine learning module 1034 and construct the mapping from the offset array. The mapping module 1036 may construct a three-dimensional lookup table (3D LUT) using the offset array which maps source attribute values from the source image to target attribute values, the target attribute values being closer to the reference attribute values. In some embodiments, the mapping module 1036 constructs a radial warp grid using the offset array. The mapping module may project the attribute values of the source image onto the warp grid, and then offset the control points of the radial warp grid to target attribute values based on the offsets in the offset array. The generated mapping may output directly to the modification module 1038.

Executing modification module 1038 may cause processor 1021 to perform an image editing process on the source image by applying the generated mapping to the source image. In some embodiments, executing modification module 1038 may cause processor 1021 to perform one or more of steps 140 and/or 150 of method 100, steps 710, 720, 730, 740, 750, 760, and/or 780 of method 700, steps 810, 820, 830, 840, 850, and/or 860 of method 800, steps 1124 and/or 1126 of method 1100 and step 1222 of method 1200. The modification module 1038 may be configured to transform the attribute values of each pixel of the source image to the target attribute values defined in the mapping. In some embodiments, the modification module 1038 may increase the similarity of attribute values between the source image and the reference image.

Attribute module 1030, encoding module 1032, machine learning module 1034, mapping module 1036, and modification module 1038, may be software modules such as add-ons or plug-ins that operate in conjunction with the image editing application 1015 to expand the functionality thereof. In alternative embodiments, modules 1030, 1032, 1034, 1036, and/or 1038 may be native to the image editing application 1015. In still further alternative embodiments, modules 1030, 1032, 1034, 1036, and/or 1038 may be stand-alone applications (running on user computing device 1010, server system 1020, or an alternative server system (not shown)) which communicate with the image editing application 1015, such as over network 1018.

Modules 1030, 1032, 1034, 1036, and/or 1038 have been described and illustrated as being part of/installed on the server system 1020, and may be configured as an add-on or extension to server application 1028, a separate, stand-alone server application that communicates with server application 1028, or a native part of server application 1028. Inputs, such as user interactions, source images and/or reference images, may be provided and/or accessed at/by the user computing device 1010, and then transferred to server system 1020, such that the attribute editing methods may be performed by the components of the server system 1020.

In some alternative embodiments (not shown), the functionality provided by one or more of modules 1030, 1032, 1034, 1036, and/or 1038 could be provided by user computing device 1010, based on locally or remotely stored image data 1024 and mapping data 1025. One or more of modules 1030, 1032, 1034, 1036, and/or 1038 may reside as an add-on or extension to image editing application 1015, a separate, stand-alone application that communicates with image editing application 1015, or a native part of image editing application 1015.

In alternate embodiments (not shown), all functions, including accessing the images may be performed by the server system 1020. In some embodiments, an application programming interface (API) may be used to interface with the server system 1020 for performing the presently disclosed methods of image editing.

Server system 1020 also comprises a communications module 1027, to facilitate communication between server system 1020 and other remote or external devices. Communications module 1027 may allow for wired or wireless communication between server system 1020 and external devices, and may use Wi-Fi, USB, Bluetooth, or other communications protocols. According to some embodiments, communications module 1027 may facilitate communication between server system 1020 and user computing device 1010, for example.

Server system 1020 may include additional functional components to those illustrated and described, such as one or more firewalls (and/or other network security components), load balancers (for managing access to the server application 1028), and or other components.

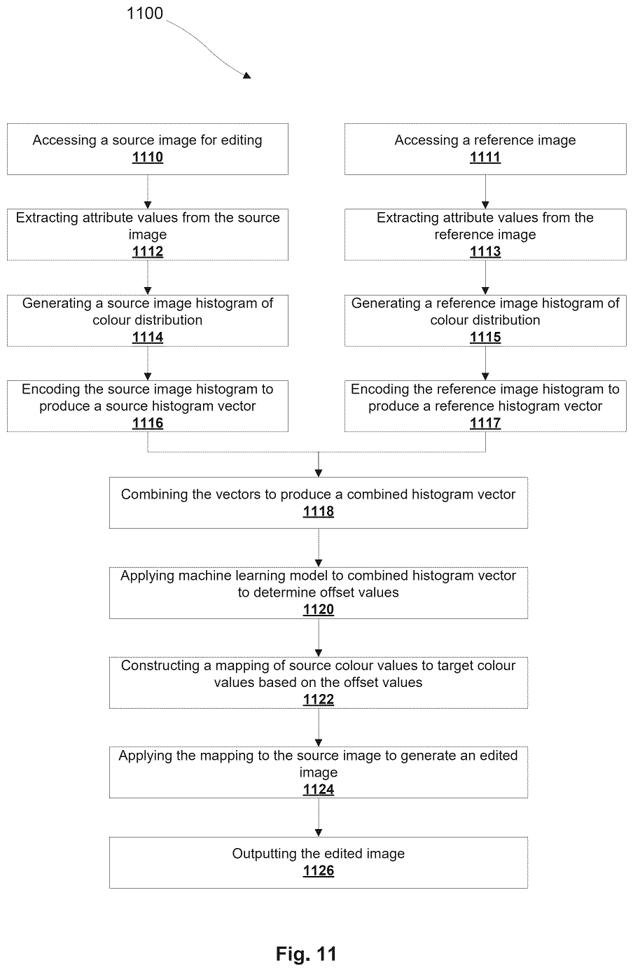

FIG. 11 is a process flow diagram of a method 1100 for modifying colour values of a source image to be more similar to the colour values of a reference image, according to some embodiments. Whilst method 1100 will be illustrated with reference to modifying colour values, it will be appreciated that method 1100 may be performed to modify any suitable attribute values to be more similar to the attribute values of a reference image. In some embodiments, method 1100 may be performed at least partially by processor 1011 executing image editing application 1015. In some embodiments, method 1100 may be performed at least partially by processor 1021 executing server application 1028. While certain steps of method 1100 have been described as being executed by particular elements of system 1000, these steps may be performed by different elements in some embodiments. Furthermore, while features of method 1100 have been illustrated and described as occurring in a particular order, some of the features may be performed in an alternative order, or in parallel, without affecting the outcome of the method.

At 1110, processor 1021 executing server application 1028 accesses a source image for editing. At 1111, processor 1021 executing server application 1028 accesses a reference image. 1110 and 1111 may be performed as described herein with reference to steps 110 and 120. In some embodiments, the source image and/or reference image may be a user-selected image. The accessing in steps 1110 and 1111 may be from a memory location, from a user I/O, or from an external device in some embodiments. In some embodiments, processor 1021 may access the source image and/or reference from image data 1024 or data 1013.

In some embodiments, the source image and/or the reference image may be sent to server system 1020 from user computing device 1010. This may be in response to a user of user computing device 1010 using a camera forming part of the user I/O 1016 to capture a source image for editing, or by the user selecting a source image and/or reference image from a memory location. The memory location may be in memory 1012 stored locally on user computing device 1010, or in the data 1023 in memory 1022 stored remotely in server system 1020. Depending on where the image editing processes are to be performed, a copy of the retrieved source image and/or reference image may be stored to a second memory location to allow for efficient access of the image file by processor 1011 and/or processor 1021. For example, a copy of the source image and/or reference image may be stored in image data 1024 of memory 1022 for access by processor 1021. The accessed images may be displayed within a user interface of the image editing application 1015, which may be displayed on a display screen (not shown) forming part of the user I/O 1016.

At 1112, processor 1021 executing attribute module 1030 extracts colour attribute values from the source image. At 1114, a source image histogram of colour distribution is then generated by the attribute module 1030 based on the colour values extracted from the source image in 1112. Similarly, at 1113, processor 1021 executing attribute module 1030 extracts colour attribute values from the reference image. At 1115, a reference image histogram of colour distribution is then generated by the attribute module 1030 based on the colour values extracted from the source image in 1113. In some embodiments, steps 1114 and 1115 may be performed as described herein with reference to steps 210 and 215 of method 200. In some embodiments, the attribute module 1030 stores the extracting colour values and the generated histograms in image data 1024 of server system 1020. In some embodiments, attribute module 1030 may be configured to perform one or more of 1110, 1112, and 1114 before or after, or in parallel, to one or more of 1111, 1113, and 1115.

At 1116, processor 1021 executing encoding module 1032, encodes the source image histogram to produce a source histogram embedding vector at 1116. Similarly, encoding module 1032 encodes the reference image histogram to produce a reference histogram embedding vector at 1117. In some embodiments, steps 1116 and 1117 may be performed as described herein with reference to 220 of method 200. In some embodiments, encoding module 1032 may be configured to perform one or more of 1116 before or after, or in parallel, to 1117.

At 1118, processor 1021 executing encoding module 1032, combines the source and reference histogram vectors to produce a combined histogram vector. In some embodiments, step 1118 may be performed as described herein with reference to 230 of method 200.

At 1120, processor 1021 executing machine learning module 1034, applies a machine learning model to the combined histogram vector to determine offset values between the source colour values and target colour values that modify the source image colours to be more similar to the reference image colours. In some embodiments, 1120 may be performed as described herein with reference to step 250 and 260 of method 200. In some embodiments, processor 1021 executing machine learning module 1034 may determine the offset values by performing method 400 and/or method 500 as described herein. The offset values may be output by the machine learning module 1034 as an array, and the array may be stored in mapping data 1025 of server system 1020. In some embodiments, the offset array may be transmitted from server system 1020 to user computing device 1010 to be stored in data 1013.

At 1122, processor 1021 executing mapping module 1036, constructs a mapping of source colour values to target colour values using the offset values output by the machine learning module 1034. In some embodiments, step 1122 may be performed as described herein with reference to 130 of method 100 and/or 270 of method 200. Mapping may be store in mapping data 1025 on server system 1020 or may be store in data 1013 of user computing device 1010.

At 1124, processor 1021 executing modification module 1038, applies the generated mapping to the source image to generate an edited image. In some embodiments, modification module 1038 may be configured to apply the generated mapping by performing method 700 and/or method 800 as described herein. Applying the mapping results in the transformation of source colour values into the target colour values to generate an edited image. The edited image therefore includes at least one target colour value which is based on the colour values of the reference image. At 1126, processor 1021 executing modification module, outputs the edited image. The edited image may be output to image data 1024 of the server system 1020, or may be output to user computing device 1010 and/or the image editing application 1015. 1126 may be performed as described herein with reference to 150 of method 100, 780 of method 700 and/or 860 of method 800.

Some embodiments relate to a method for training a machine learning model to edit an image. The trained machine learning model may then be used to determine offset values between the source attribute values and target attribute values, as described above with reference to steps 250 of method 200, steps 410, 420, 430, 440, 450, 460, 470, and/or 480 of method 400, steps 510, 520, 530, 540, 550, and/or 560 of method 500 and step 1120 of method 1100. The trained machine learning model can then be used to determine offset values between the source colour values and target colour values as described above with reference to step 1120. The method for training a machine learning model may be performed by a training module (not shown) which forms part of the machine learning module 1034.

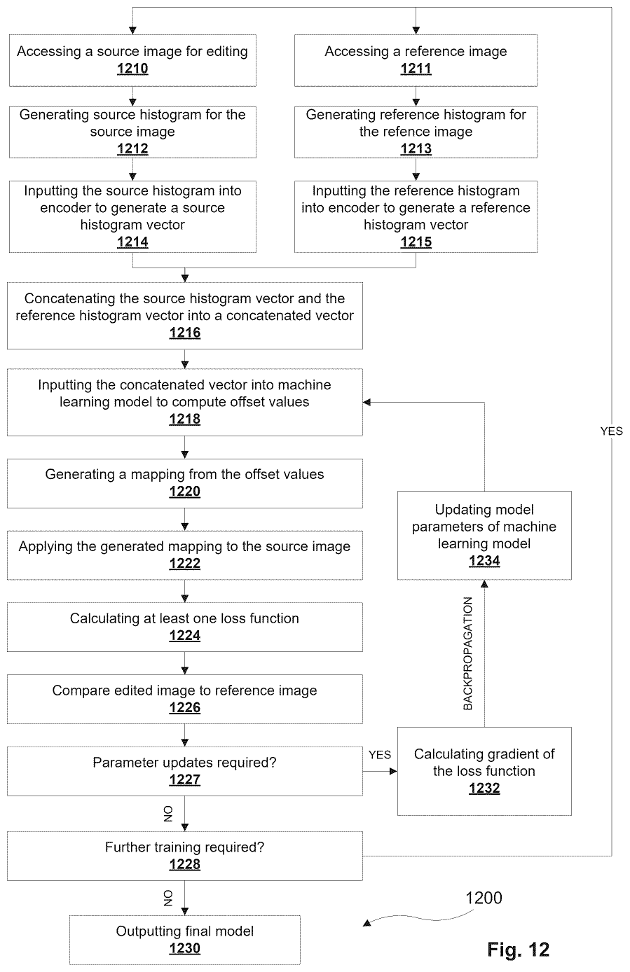

FIG. 12 is a process flow diagram of a method 1200 for training a machine learning model to edit an image, according to some embodiments. The method may be used to configure and train a machine learning model to perform step 1120 of method 1100 described herein and/or other associated actions, for example, performing methods 400 to determine offset values and 500 to adjust positions of control points on a warp grid.

At 1210, processor 1021 executing attribute module 1030 accesses a source image for editing and at 1211 accesses a reference image. In some embodiments, 1210 and 1211 may be performed as described above with reference to 1110 and 1111 of method 1100. The attribute module 1030 generates a source histogram for the source image at 1212, and a reference histogram for the reference image at 1213. The source histogram and the reference histogram represent distribution of attribute values in the source image and reference image respectively. In some embodiments, 1212 and 1213 may be performed as described above with reference to 1112, 1113, 1114 and 1115 of method 1100.

At 1214, processor 1021 executing encoding module 1032, inputs the source histogram into an encoder to generate a source histogram vector. Similarly, at 1215 the encoding module 1032 inputs the reference histogram into an encoder to generate a reference histogram vector. In some embodiments, 1214 and 1215 may be performed as described above with reference to 1116 and 1117. At 1216, the encoding module concatenates the source histogram vector and the target histogram vector into a concatenated vector. In some embodiments, 1216 may be performed as described above with reference to 1118 of method 1100.

At 1218, processor 1021 executing training module inputs the concatenated vector into a machine learning model to determine offset values. The machine learning model is a machine learning model that is being trained. The machine learning model to be trained by me accessed through the machine learning module 1034.

At 1220, after the training module outputs the determined offset values, processor 1021 executing mapping module 1036 uses the offset values output by the training module to generate a mapping of source attribute values to target attribute values. At 1222, processor 1021 executing modification module 1038, applies the generated mapping to the source image to generate an edited image which is then provided to the training module.

At 1224, the processor 1021 executing training module, calculates at least one loss function based on the output edited image. In some embodiments, a plurality of loss functions are derived based on the edited image. The loss functions may be histogram-based loss functions. In some embodiments, the derived loss functions may be combined with constraint losses, for example, control point constraint losses. This loss can then be used for a backward pass.

At 1226, processor 1021 executing training module, compares the edited image to the reference image. At 1227, the training model determines whether the model parameters should be updated based on the comparison. If model parameters require updating, then at 1228, the training module calculates the gradient of the loss function and feeds this into a backpropagation algorithm. The backpropagation algorithm uses the gradient of the loss function with respect to the machine learning model's parameters to adjust and/or update the parameters to minimise loss at 1234. The training module reapplies the machine learning model at 1218 to compute the offset values with updated parameters, thereby improving the model's determination of the offset values based on the source image and reference image provided at 1210 and 1211 respectively.

If the model parameters do not require updating, at 1228 the training module determines whether further training is required for the machine learning model. If no further training is determined to be required, at 1230 processor 1021 executing training module, outputs the final trained machine learning model. If further training is determined to be required, the processor 1021, executing training module, reverts back to steps 1210 and/or 1211 to access new source and/or reference images for further training the model to determine offset values.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A method for editing an image, the method comprising:
accessing a source image for editing;
accessing a reference image;
generating a mapping, wherein the mapping relates at least one source attribute value to at least one target attribute value; and
modifying the source image to generate an edited image by applying the generated mapping, the edited image having at least one attribute value based on the attribute values of the reference image.

2. The method according to claim 1, wherein the source attribute value and the target attribute value are colour values;
wherein generating a mapping comprises generating a mapping at least partially based on the source image and the reference image, wherein the mapping relates at least one source colour value to at least one target colour value; and
wherein the edited image has at least one colour value at least partially based on the colour values of the reference image.

3. The method according to claim 1, wherein the mapping relates a plurality of source attribute values to a plurality of target attribute values, wherein each source attribute value relates to a single target attribute value.

4. The method according to claim 1, wherein the target attribute values are determined using at least the attribute values of the reference image.

5. The method according to claim 1, wherein the edited image having at least one attribute value based on the attribute values of the reference image comprises having the at least one attribute value closer to the one or more attribute values of the reference image.

6. The method according to claim 5, wherein the at least one attribute value being closer to one or more attribute values of the reference image comprises the at least one attribute value being within a specified range of the one or more attribute values of the reference image.

7. The method according to claim 5, wherein the at least one attribute value being closer to one or more attribute values of the reference image comprises a first difference between the at least one attribute value and the one or more attribute values of the reference image being less than a second difference between the at least one attribute value and one or more attribute values of the source image.

8. The method according to claim 1, wherein the method further includes at least one of
generating a source histogram of a distribution of source attribute values for the source image, and inputting the source histogram into an encoder to generate a source histogram representation; and,
generating a reference histogram of the distribution of reference attribute values for the reference image, and inputting the reference histogram into an encoder to generate a reference histogram representation.

9. The method according claim 1, wherein the method further includes:
generating a source histogram of a distribution of source attribute values for the source image, and inputting the source histogram into an encoder to generate a source histogram representation; and,
generating a reference histogram of the distribution of reference attribute values for the reference image, and inputting the reference histogram into an encoder to generate a reference histogram representation; and,
wherein the generating the mapping includes combining the source histogram representation and the reference histogram representation to produce a combined histogram representation.

10. The method according to claim 9, wherein generating the mapping includes applying a machine learning model to the combined histogram representation to generate the mapping.

11. The method according to claim 1, wherein generating the mapping includes determining one or more control points for the mapping, the control points controlling mapping between at least one source attribute value and at least one target attribute value.

12. The method according to claim 11, wherein the mapping includes a radial warp grid.

13. The method according to claim 12, wherein the control points define a peripheral edge of the radial warp grid.

14. The method according to claim 10, wherein generating the mapping includes:
determining an offset value for each of the one or more control points, the offset value being a difference between an original position of a control point and a final position of the control point after the control point has been adjusted to reach the target attribute values; and
outputting an offset array containing the offset values for each of the one or more control points.

15. The method according to claim 14, wherein at least one of
an offset value comprises X and Y offsets for each of the one or more control points; and,
generating the mapping includes constructing the mapping from the offset array.

16. The method according to claim 1, wherein applying the generated mapping to the source image includes transforming the attribute value of each pixel of the source image to the target attribute values defined in the mapping.

17. The method according to claim 1, wherein modifying the image increases a similarity of attribute values between the source image and the reference image.

18. The method according to claim 1, further comprising:
outputting the edited image; and/or
storing the editing image to memory; and/or
transmitting the edited image to a computing device.

19. A method for training a machine learning model to edit an image, the method comprising:
accessing a source image for editing;
accessing a reference image;
generating a source histogram for the source image and a reference histogram for the reference image;
inputting the source histogram and the reference histogram into an encoder to generate a source histogram vector and a reference histogram vector;
concatenating the source histogram vector and the reference histogram vector into a concatenated vector.
inputting the concatenated vector into the machine learning model;
generate a mapping using the machine learning model;
applying the mapping to the source image;
calculating at least one loss function; and
updating parameters of the machine learning model based on the at least one loss function.

20. A computing device comprising:
non-transitory computer-readable storage medium storing instructions which, when executed by a processing device, cause the processing device to perform the method of claim 1; and
a processor configured to execute the instructions stored in the non-transitory computer-readable storage medium.
